(19) United States
(12) Patent Application Publication
(10) Pub. No.: US 2009/0048856 A1
(43) Pub. Date: Feb. 19, 2009

(54) System and method for managing vendor information of vendors that repair deficiencies at facilities

(75) Inventors: Clark David Howell, Fort Worth, TX (US); Joe Paul Robertson, Fort Worth, TX (US)

Correspondence Address: PATTON BOGGS, LLP, 2001 ROSS AVENUE, SUITE 3000, DALLAS, TX, 75201, US

(73) Assignee: Facility Audit Solutions, LLC

(21) Appl. No.: 11/893,437

(22) Filed: Aug. 16, 2007

(51) Int. Cl. G06F 17/30; G06Q 10/00

(52) U.S. Cl. 705/1

(57) ABSTRACT

A system and method for managing vendor information to repair deficiencies at facilities may include storing vendor information of vendors. The vendor information may identify one or more deficiencies of which at least one of the vendors is capable of repairing. Site audit information of one or more facilities may be aggregated. Vendor information of one or more vendors capable of repairing a deficiency at the facilities may be displayed to enable selection of one or more vendors for repairing the deficiency at a facility.

### BACKGROUND

The restaurant industry has experienced significant growth over the past thirty years. One aspect of that growth has been the daunting task of repairing, maintaining, and upgrading buildings, equipment, and systems within the restaurants. Chain restaurants typically employ facility managers to ensure that preventative maintenance, emergency repairs, and upgrades are handled in a timely and cost effective manner. Facilities managers' jobs have become increasingly difficult due to increased number of locations, age of existing locations, and trend toward site auditing each location on a regular basis to proactively identify potential problems and/or upgrades. A site audit is an audit performed on physical characteristics of a facility.

While site auditing of facilities to attempt to anticipate repairs that will be needed to properly maintain a facility is performed by facilities maintenance managers, the site audits are generally limited to site auditing the facilities on a local basis. The results of these site audits typically result in site audit information or data being included in discrete data files or databases that have limited capabilities to properly maintain and manage a large number of facilities. Moreover, site auditors who use photographs to capture images of a facility to show deficiencies occurring within the facility are often subject to spending a large amount of time to organize the photographs during or after an site audit so that a facilities manager can visually understand the results of the site audit and make determinations as to how repairs need to be conducted. A deficiency is an item at a facility that has been identified as possibly needing to be repaired, replaced, or upgraded. For example, an auditor who site audits a facility typically makes notes on paper or creates a rudimentary data file on a portable computer and takes photographs on a digital camera. After completion of the site audit, the auditor uploads the photographs from the digital camera into a file folder on a computer and labels each photograph to associate the notes made during the site audit with the photographs. This site audit post-processing effort can be very time consuming for an auditor. As a result, site audits can be expensive and provide a facilities manager with enough information to make decisions about repairs for a single facility, but limited capabilities of understanding general trends of deficiencies occurring across multiple facilities. As a result, facilities managers spend more money in site auditing and repairing of facilities.

While site auditing has become an increasingly important aspect of maintaining restaurants, such as chain restaurants with many facilities, the ability for other industries to manage infrastructure has also become an issue of concern. For example, the airline industry includes airline carriers that purchase and operate very expensive airplanes. These airplanes are routinely serviced and inspected to ensure proper operation. The banking industry also has banks with many locations that operate facilities and equipment. Hotels, motels, and other chain store businesses also have matured to the point that facilities being operated are increasingly finding maintenance to be issues of concern and managing the maintenance and repairs is becoming expensive in terms of overhead for these companies. Governments must also manage and maintain its infrastructure, including roadways, bridges, military equipment, etc., and managing and maintaining information of infrastructure by the government is a very large task.

### SUMMARY

To overcome the problem of facilities managers having a limited ability to manage information associated with site auditing of a facility, the principles of the present invention provide for a system and method for managing site audit information of the facility. The system may include a server that manages site audit information, which may include information of deficiencies and associated photographs of deficiencies of a facility, in a manner that a facilities manager may be able to manage and manipulate the site audit information in a way that he or she can make decisions for repairing the facilities in a more cost effective and timely manner. For example, the facilities manager may be able to budget individual projects to repair deficiencies found in site audits of the facilities and aggregate the budgets for repairing the deficiencies, thereby providing the facilities manager with the ability to repair common problems with each of the facilities in a more cost effective manner. If, for example a common deficiency exists across many facilities of a chain restaurant then the facilities manager may be able to request bids from one or multiple contractors for repairing the common deficiency across all of the facilities, thereby allowing for a cost savings due to contractors awarded a contract to repair the common deficiencies being able to purchase materials in bulk to repair the common deficiency.

In addition, the system may be configured to manage the information in a way that an auditor may simply upload site audit information that includes deficiency information and photographs associated with the deficiencies and the system may automatically manage the photographs in a manner such that the auditor does not have to perform post-audit work to associate the photographs with the notes of deficiencies made during a site audit. Furthermore, the auditor may be able to quickly generate site audit information by using a handheld computing device that has site audit information pre-programmed therein. The handheld computing device may download information stored on the server associated with each facility being site audited, thereby enabling the auditor to identify deficiencies found at the facility, mark a location on a graphical representation of the facility to indicate the location of the deficiency, make notes and optionally take photographs of the deficiency so that a facilities manager may understand the location of the deficiencies and nature of the deficiencies that is consistent with each auditor making a site audit of the facilities. In other words, terms for deficiencies may be standardized through the use of the system in accordance with the principles of the present invention.

An embodiment of a system for managing vendor information for repairing deficiencies at facilities may include a storage unit and a data repository stored on the storage unit. The data repository may be configured to store vendor information, where the vendor information identifies one or more deficiencies of which at least one of the vendors is capable of repairing. A processing unit may be in communication with the storage unit, and be configured to locate one or more vendors capable of repairing a deficiency at a facility. A user interface may be configured to display the vendor information and enable selection of one or more vendors for repairing the deficiency at the facility.

One embodiment of a method for managing vendor information to repair deficiencies at facilities may include storing vendor information of vendors, where the vendor information may identify one or more deficiencies of which at least one of the vendors is capable of repairing. Site audit information of one or more facilities may be aggregated. Vendor information of one or more vendors capable of repairing a deficiency at the facilities may be displayed to enable selection of one or more vendors for repairing the deficiency at a facility.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an audit manager and other entities with which the audit manager communicates in performing site audits of facilities for customers and repairing the facilities;

FIG. 2 is a flow chart of an exemplary process for performing a site audit;

FIG. 3 is a block diagram of an exemplary network for managing and collecting site audit information;

FIG. 4 is a block diagram of an exemplary customer audit server for managing and collecting site audit information generated by auditors of facilities;

FIG. 5 is a block diagram of exemplary software modules executed by the customer audit server of FIG. 4 for managing, processing, displaying, and communicating site audit information collected by auditors of facilities;

FIGS. 6A-6C are screenshots of exemplary graphical user interfaces for enabling a manager to perform budgeting and contracting of repairs on deficiencies of facilities that have been audited;

FIG. 7 is an illustration of an exemplary map showing customer facilities and vendors available to repair deficiencies within the customer facilities;

FIG. 8 is a screenshot of an exemplary e-mail communicated to a potential vendor for repairing deficiencies within a facility of a restaurant;

FIGS. 9A-9C are screenshots of exemplary graphical user interfaces showing site plan views and picture views of a facility of a chain of restaurants;

FIGS. 10A-10D are screenshots of exemplary graphical user interfaces showing lists of deficiencies, site plans of a deficiency, and picture of a deficiency determined during an audit of the facilities;

FIGS. 11A-11D are screenshots of exemplary graphical user interfaces when aggregated site audit information generated by determining deficiencies at facilities;

FIG. 12 is a screenshot of an exemplary custom query GUI to enable a user to query a database of facility information or site audit information;

FIG. 13 is a flow chart of an exemplary process for managing site audit information;

FIG. 14 is a block diagram of exemplary software modules used to collect and manage site audit information of customers having facilities in an aggregate manner;

FIG. 15 is a flow chart of an exemplary process for collecting and managing site audit information collected from multiple customers of an audit manager;

FIGS. 16A-16C are illustrations of an exemplary handheld computing device used for performing site audits on facilities; and

FIG. 17 is a flow chart of an exemplary process for identifying and documenting deficiencies at a facility.

### DETAILED DESCRIPTION OF THE DRAWINGS

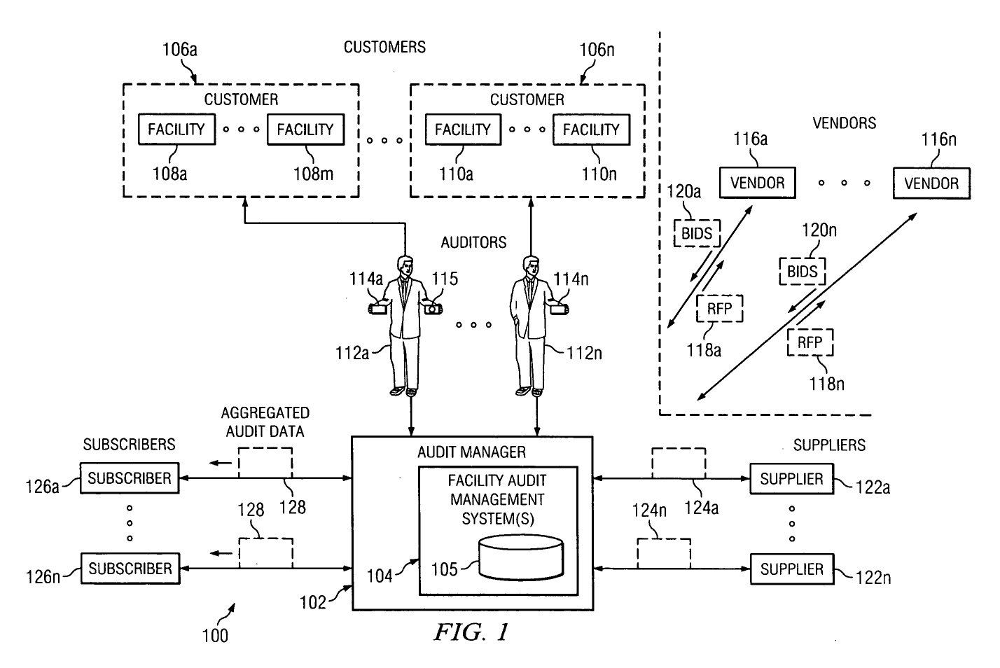

FIG. 1 is an illustration of an audit manager and other entities with which the audit manager communicates in performing site audits of facilities for customers and repairing the facilities. An audit manager 102 may be considered a developer and/or manager of facility audit management system(s) 104 that are used for managing collection and maintenance of site audit information collected from facilities. The site audit information is information indicative of one or more physical properties of a facility. The site audit information may include text, photographs, numbers, graphics, sketches, or any other information that is descriptive of a physical property of a facility. The facility audit management system(s) 104 may include at least one database 105 that stores the site audit information of deficiencies of facilities collected during site audits. Customers 106a-106n (collectively 106) of the audit manager 102 may be an operator or owner of one or more facilities that are to be site audited. For example, customer 106a owns or operates facilities 108a-108m and customer 106n owns or operates facilities 110a-110n. The customers may be individuals, corporate entities, or governmental entities. The term “facility” or “facilities” may refer to any physical structures (e.g., buildings, houses, condominiums, apartment, schools, hospitals, hotels, retail stores, commercial facilities, gas stations, etc.), infrastructure (e.g., roads, bridges, tunnels, sidewalks, parks, parking lots, etc.), transportation vehicles (e.g., automobiles, airplanes, trucks, boats, trains, etc.), equipment (e.g., food processing equipment, cleaning equipment, construction equipment, maintenance equipment, etc.), systems (e.g., air conditioning, heating, etc.), land (e.g., farm, plot, waterway, etc.), or any other asset that may be site audited using the principles of the present invention.

Auditors 112a-112n (collectively 112) are people appointed and authorized to examine a facility. The auditors 112 maybe employees of the customers 106, employees of the audit manager 102, or third party employees who are contracted to perform site audits on the facilities of the customers 106.

Each of the auditors 112 may perform a site audit of a facility using handheld computing devices 114a-114n (collectively 114). The handheld computing devices maybe any device capable of allowing the auditor to access pre-site audit information of a facility to use during the site audit and communicate site audit information generated during the site audit by the auditor to the facility audit management system(s) 104. More specifically, the handheld computing devices 114 maybe portable computers, ultra mobile personal computers, wireless devices, such as BlackBerry® handheld devices, mobile phones, or any other wireless device that is capable of allowing the auditors to access facility information and generate site audit information while site auditing the facility. It should be understood that the list of handheld computing devices is exemplary and that any mobile, portable, or wireless device capable of performing functions in accordance with the present invention may be utilized. In addition, the handheld computing devices 114 may include built-in cameras to take photographs of deficiencies found in facilities or the auditors 112 may utilize digital cameras 115 that are capable of communicating photographs taken during a site audit to the handheld computing devices 114.

Vendors 116a-116n (collectively 116) are individuals or businesses that are typically contracted to repair deficiencies found from a site audit of a facility. The vendors 116 may use computing equipment operating on a network such as the Internet (not shown), to communicate with the audit manager 102 to receive requests for proposals (RFPs) 118a-118n (collectively 118) and, optionally, submit bids 120a-120n (collectively 120). The RFPs 118 may be communicated to the vendors 116 in the form of e-mails, notices to download RFPs stored on a system, documents, or any other method for a vendor 116 to access or otherwise receive information on a network as understood in the art. It should be understood that although the audit manager 102 is shown to be communicating with the vendors 116 that the customers 106 may operate a system within the facility audit management systems 104, such as a server, at a customer location or the audit manager 102 may operate the server for the customers 106. If the customers 106 operate a facility audit management system, then the vendors 116 would communicate directly with the customers 106 via the facility audit management system 104.

In addition to the audit manager 102 communicating with the vendors 116, suppliers 122a-122n (collectively 122) may communicate with the facility audit manager system(s) 104. The suppliers may be manufacturers or distributors of goods used for making repairs to facilities. For example, the goods may include tiles, bricks, doors, windows, or any other structural element or substrate of a building, for example. Alternatively, the suppliers 122 may be suppliers of any other parts used in different types of facilities, such as parts for vehicles. The suppliers may access information 124a-124n (collectively 124) that maybe used for repairing the facilities on an aggregate basis. For example, if the facility audit management system 104 of a customer or many customers aggregates information for different parts or materials used for repairing the same or similar facilities, the suppliers may determine that a particular product may be in demand on a short term basis. For example, if auditors determine that customers need a certain amount of marble to replace or repair countertops, then a marble supplier may determine that increased production of marble countertops is needed for a customer of the audit manager 102 and produce countertops. Alternatively, rather than the suppliers 122 communicating with the audit manager 102 directly, the vendors 116 may, in preparing bids 120 for customers 106 of the audit manager 102, communicate with the suppliers 122 for determining availability and cost of products to be used for repairing the facilities.

The audit manager 102 may further collect and aggregate site audit information of customers and “sanitize” (i.e., remove customer information, such as a specific restaurant chain, associated with site audit information to avoid disclosure of confidential information and maintain privacy of customers) the information so that industry trends, product durability, product value, or other information associated with products used to construct or repair facilities may be generated by the facility audit management system 104. In addition, the audit manager 102 may generate or accumulate information associated with the vendors 116 that describe vendor quality, vendor timeliness, or any other parameter associated with a vendor so that customers 106 or others may be able to use the information when determining whether or not to hire a particular vendor. Furthermore, information about suppliers 122 may be gathered that describes quality of products produced by suppliers, timeliness of supplies, or any other parameter associated with a supplier in which the customers, vendors, trade associations, representatives, distributors, or others might be interested. The facility audit management system 104 maybe configured to enable subscribers 126a-126n (collectively 126) who may or may not be customers 106, vendors 116, or suppliers 122, to have access.

The sanitized information maybe aggregated site audit information 128 that maybe accessed by the subscribers 126 for the purposes of understanding industry trends, for example. In one embodiment, a subscriber 126 may be interested in determining how much tile is being repaired on an annual basis by customers in the restaurant industry. Alternatively, trends about the number of soda dispensers that are replaced each year within the fast food industry may be of interest to the subscribers 126. It should be understood that any type of site audit information collected from site audits for any industry group may be utilized to produce aggregated or non-aggregated data that may be of interest to the subscribers 126. In addition, the customers 106 may be interested in information about particular vendors or vendors in the aggregate that perform one or more types of repairs for facilities. It should be further understood that any information collected by the facility audit management system(s) 104 may be utilized to generate statistics may be used for providing to subscribers 126 or any other individual or business entity that is established to communicate with the facility audit management system 104. Furthermore, the facility audit management system 104 may be configured to allow both passive and active collection or receipt of information generated or stored by the facility audit management system 104. For example, a newsletter or other industry report may be communicated to the subscribers 126 without the subscribers 126 having to access a website or other network location by the subscriber 126.

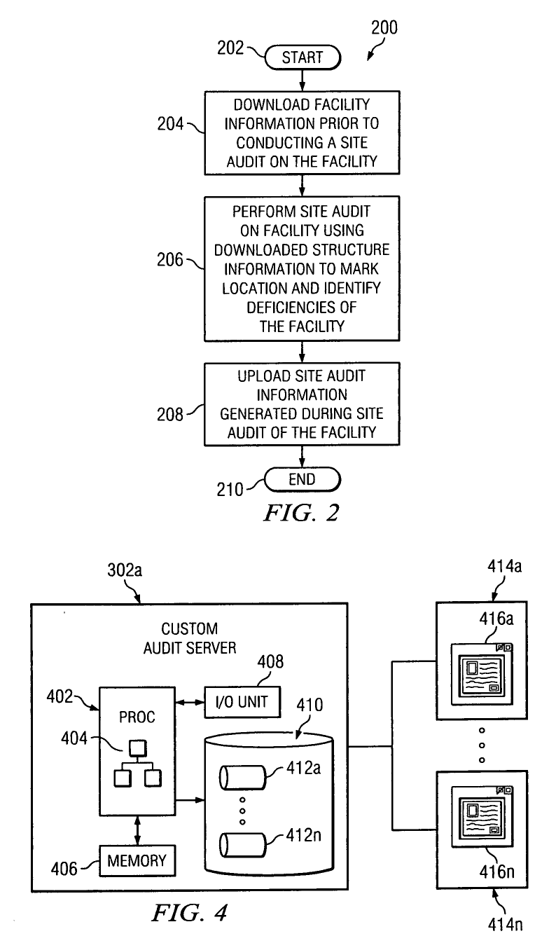

FIG. 2 is a flow chart of an exemplary process 200 for performing a site audit. The process 200 starts at step 202. At step 204, facility information may be downloaded prior to conducting a site audit on the facility. The facility information may be downloaded to a handheld computing device, such as handheld computing device 114 of FIG. 1. The facility information may include any information associated with the facility that may assist an auditor to perform a site audit. For example, the facility information may include demographic information associated with the facility, such as name, address, size of the facility, names of managers or other contacts at the facility, etc. In addition, the facility information may include a graphical representation of the facility. For example, the graphical information may include layouts, schematics, photographs, sketches, floor plans, elevations, or any other graphical representation of a facility that an auditor may use during the site audit. In using the graphical representation, and as further described hereinafter, the auditor may display the graphical representation on the handheld computing device and select a point or location on the graphical representation to indicate that a deficiency exists at that point or location. The point or location of the deficiency may be defined by positional coordinates that define an approximate location of the deficiency within a facility. The positional coordinates may be defined relative to reference coordinates (e.g., (0,0) associated with a front door of a restaurant) at the facility or global coordinates (e.g., using global positioning system coordinates). Other information maybe associated with that point or location that describes the deficiency of that point or location. For example, if a deficiency, such as broken tiles, exists on a floor of the facility (e.g., bathroom floor within a restaurant), then the auditor may select a point on a floor plan showing the bathroom floor and indicate in a selection element, such as a pull-down menu, or text entry field, for example, to indicate that the tiles on the bathroom floor are broken and need to be replaced.

At step 206, a site audit is performed on the facility using the downloaded facility information to mark location and identify deficiencies of the facility. As described, the auditor may select a point on the graphical representation being displayed and enter information associated with one or more deficiencies at the location. In one embodiment, the audit information associated with a deficiency may include photographs of the deficiency. After the site audit is performed on the facility, the site audit information generated during the site audit of the facility may be uploaded at step 208. The site audit information may be uploaded to a server, such as the facility audit management system(s) 104 being operated by the audit manager 102 (FIG. 1) or customer 106a, for example. The information, such as photographs, may be managed by the facility audit management system(s) 104. It should be understood that downloading and uploading the facility information or site audit information may be performed over a wired network wireless network, or any other communication medium as understood in the art. The process 200 ends at step 210.

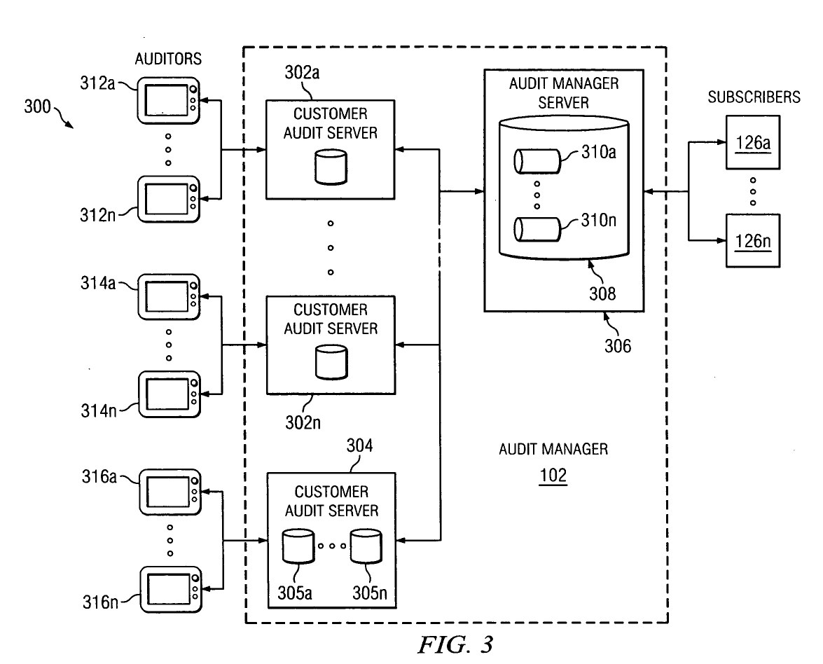

FIG. 3 is a block diagram of an exemplary system and network 300 for managing and collecting site audit information. The system and network 300 may include the audit manager 102 that operates customer audit servers 302a-302n (collectively 302) that are configured to manage an individual customer's audit system. Customer audit server 304 may be another configuration of an audit server that is configured to manage more than one customer's audit system on a single server. In other words, the customer audit server 304 may operate or communicate with multiple storage units 305a-305n or a single storage unit that includes multiple databases, one for each customer being managed by the customer audit server 304. The audit manager 102 may have an interest to collect and/or manage audit information, both pre-site audit and post-site audit information, to generate aggregate information and statistical information on an audit manager server 306. The audit manager server 306 may include a storage unit 308 that stores one or more databases 310a-310n (collectively 310), where one or more databases may store pre-site audit information (e.g., facility information) and one or more databases may store post-site audit information (e.g., site audit information collected at one or more customer's facilities). The audit manager server 306 may be configured to enable subscribers 126 to access or receive the information collected and generated by the audit manager server 306.

The customer audit server 302a may be configured to enable auditors to use handheld computing devices 312a-312n (collectively 312) to download and upload information, such as facility information and site audit information. The communications may occur via a docking station, wirelessly, over a network or otherwise. The customer audit server 302n may have auditors that use handheld computing devices 314a-314n that may download and upload information associated with a customer with facilities. Customer audit server 304, which is configured to manage more than one customer's site audit information, may also communicate with handheld computing devices 316a-316n that auditors use for performing site audits on each of the customers' facilities for which facility and site audit information are being managed by the customer audit server 304. Although each of the customer audit servers 302 are shown to be within the audit manager 102, it should be understood that one or more of the customer audit servers 302 may be located within the premises of a customer, customer 106a of FIG. 1, for example, and the audit manager 102 may operate or manage the customer audit servers 302 located at a customer's premises remotely via a network such as the Internet. In addition, a third party hosting or management service may operate a customer audit server, such as customer audit server 302 and/or 304.

FIG. 4 is a block diagram of an exemplary customer audit server 302a for managing and collecting site audit information generated by auditors of facilities. The customer audit server 302a includes a processor unit 402 that executes software 404. The processor unit 402 may include one or more processors that operate to execute the software 404 to perform a variety of functions for a customer to perform site audits. The customer audit server 302a further includes a memory 406, an input/output (I/O) unit 408, and storage unit 410 to which the processing unit 402 communicates. The memory 406 may be utilized to store site audit information or computations being made during processing of the site audit information. The memory 406 may further be used to process or transfer facility information, such as photographs, when the processing unit 402 is creating facility information to be used for performing a site audit. The I/O unit 408 may be utilized to perform downloads and uploads with handheld computing devices, such as handheld computing units 312 (FIG. 3). The I/O unit 408 may be used for communicating information over a network, such as the Internet, local area network (LAN), or any other network. The storage unit 410 may be configured to store one or more databases 412a-412n that store facility information and site audit information for each of the facilities owned or managed by a customer.

A customer that is using or managing the customer audit server 302a may use computing devices 414a-414n (collectively 414) that interface with the customer audit server 302a to allow a manager at the customer to monitor and manage site audits and the facilities being site audited. The computing devices 414a may be personal computers, desktop computers, laptop computers, handheld computers, or any other computing device or interface device, such as a terminal, that will enable the manager, such as a facilities manager, to view, process, input, or otherwise access the facility information and site audit information being stored in the storage unit 410. The computing devices 414 may be configured to display one or more graphical user interfaces 416a-416n that allow the manager to view and manipulate facility and site audit information being stored by the storage unit 410.

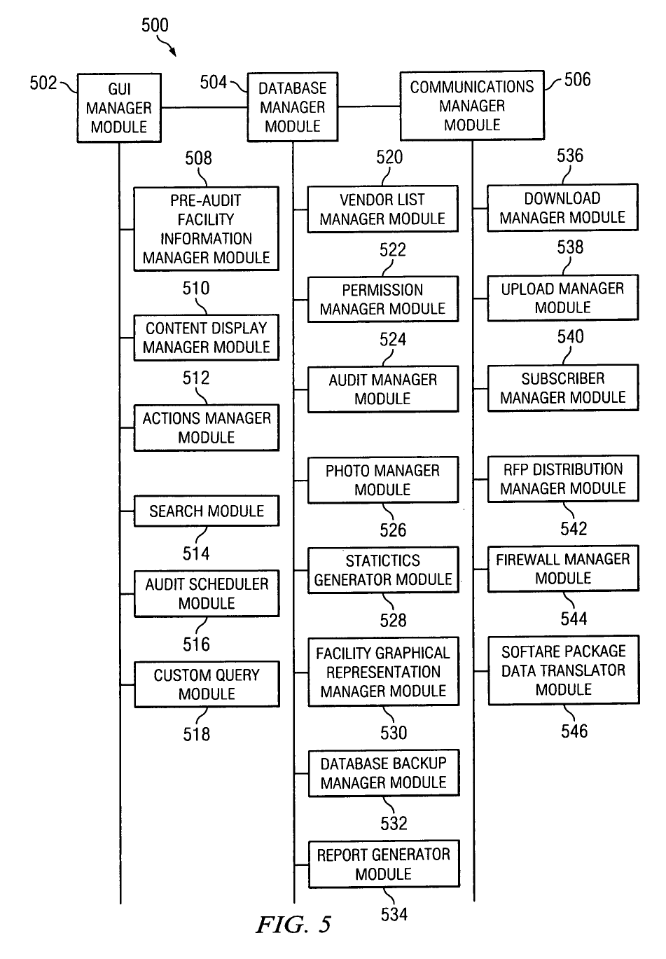

The software 404 may be configured to perform many different functions that the customer audit server 302a is used by the manager to manage the graphical user interfaces 406, databases 412, and communications. A variety of exemplary software modules are provided in FIG. 5 to perform the various functions that the customer audit server 302a can perform by the manager or automatically in response to receiving site audit information or interfacing with handheld computing devices.

FIG. 5 is a block diagram of exemplary software modules 500 executed by the customer audit server of FIG. 4 for managing, processing, displaying, and communicating site audit information collected by auditors of facilities. The software modules 500 may include three or more core software modules, including a graphical user interface (GUI) manager module 502, database manager module 504, and communications manager module 506. The graphical user interface manager module 502 may be used to manage a graphical user interface and operations performed thereon. The database manager module 504 may be used to manage one or more databases and functions performed thereon. The communications manager module 506 may be utilized to manage communications to and from a customer audit server 302a (FIG. 4). The software modules 500 may be software modules that are part of software 404 (FIG. 4) operated on the customer audit server 302a. Although shown as three basic modules, it should be understood that fewer or more modules may be utilized in performing the functions by the customer audit server 302a.

The GUI manager module 502 may include a number of modules used for managing a GUI. The modules may include a pre-audit facility information manager module 508, content display manager module 510, actions manager module 512, search module 514, audit scheduler module 516, and customer query module 518. It should be understood that other modules may be utilized to manage a GUI that a user or manager and a customer or audit manager 102 may operate.

The pre-audit facility information manager module 508 may be software that is utilized to manage facility information that is established for an auditor to download into a handheld computing device prior to performing a site audit on a facility. The facility information may include demographic information of facilities, such as locations, addresses, sizes, contact names, or any other information associated with a facility. In addition, the facility information may include graphical representations, such as floor plans, elevations, overhead views, photographs, hand sketches, or any other graphical representation that an auditor may use during a site audit of the facilities to be site audited. In addition, the facility information may include information associated with inventory of assets, such as equipment or systems that are located at the facilities. For example, the inventory information of a restaurant may include the number of tables, chairs, kitchen utensils, eating utensils, or any other inventory items that may be audited during a site audit at the facilities. The system information may include any types of systems, such as heaters, furnaces, air conditioners, or any other system information that may be located at a facility that an auditor may check to determine operation during a site audit. The pre-audit facility information manager module 508 may manage the information in a way that can be displayed on the graphical user interface by a user entering or reviewing prior to an auditor using the facility information. For example, the GUI may have separate screens that are used to display the facility information.

The content display manager module 510 may be configured to manage display of contents being displayed on the graphical user interface. The content may be displayed in certain formats, such as showing dollar amounts, dimensions, image sizes, or any other representation on a GUI. The content display manager module 510 may be used for managing contents of both facility information and site audit information on one or more graphical user interfaces.

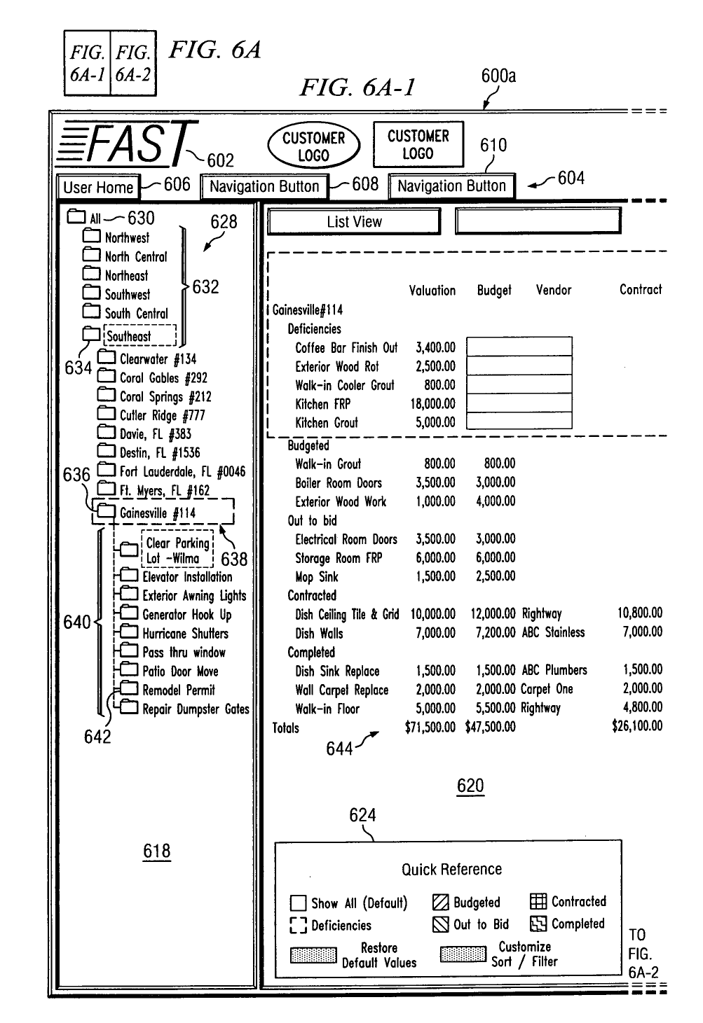

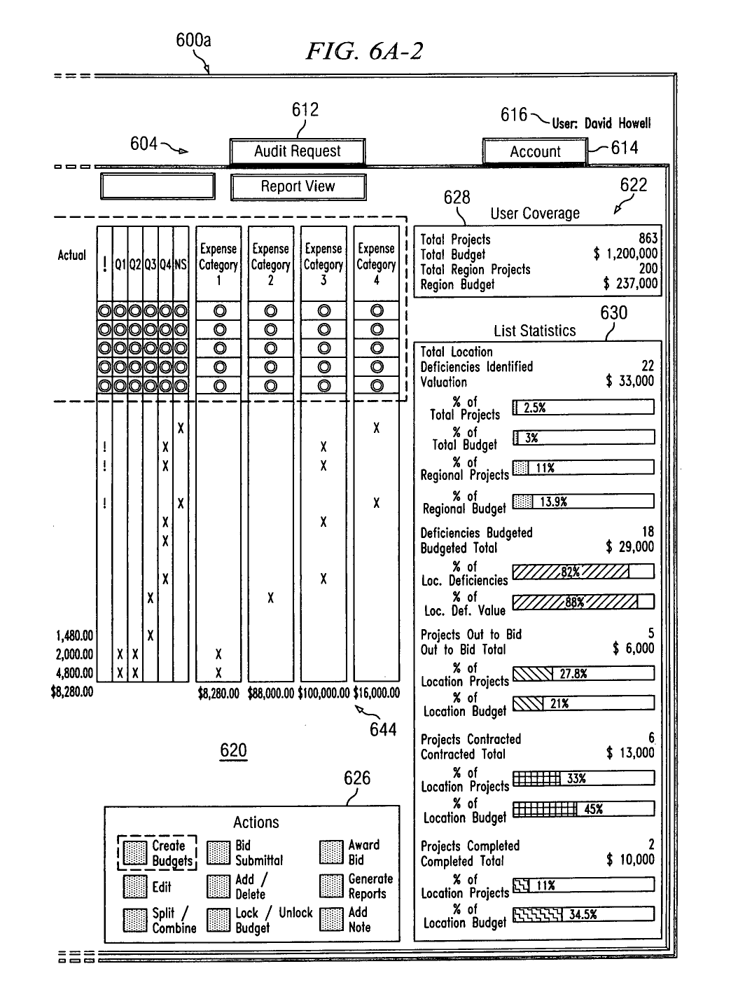

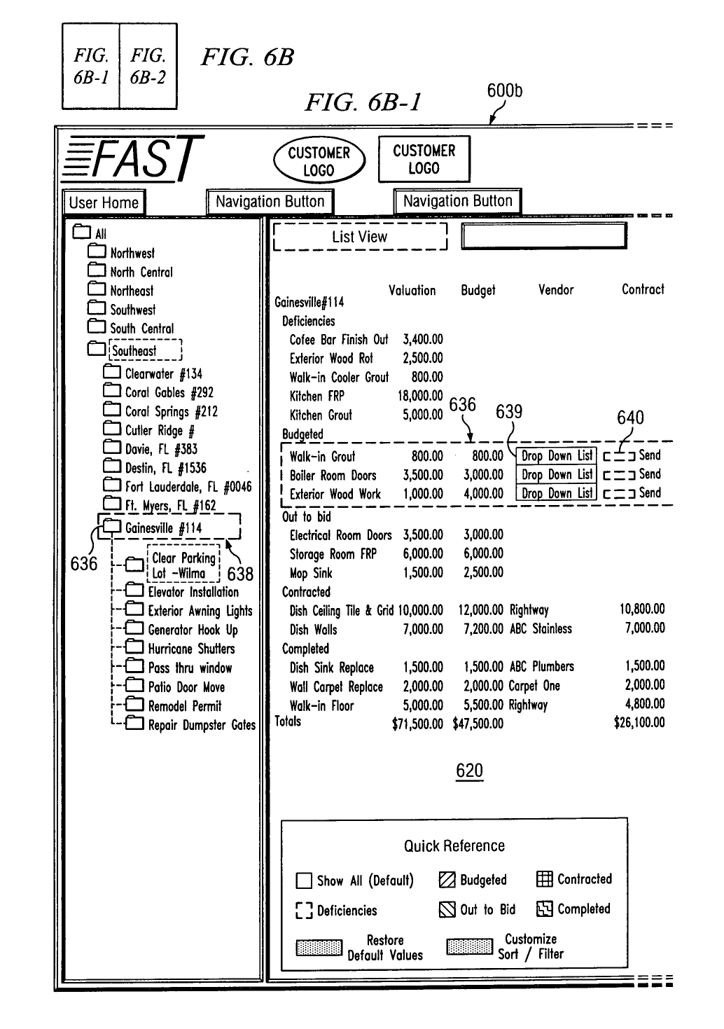

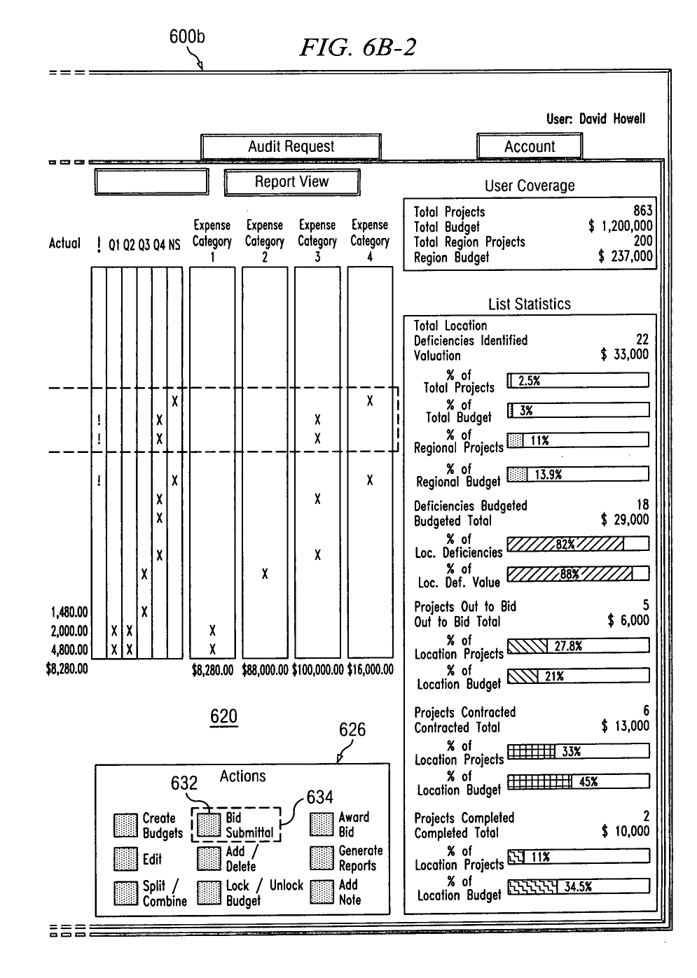

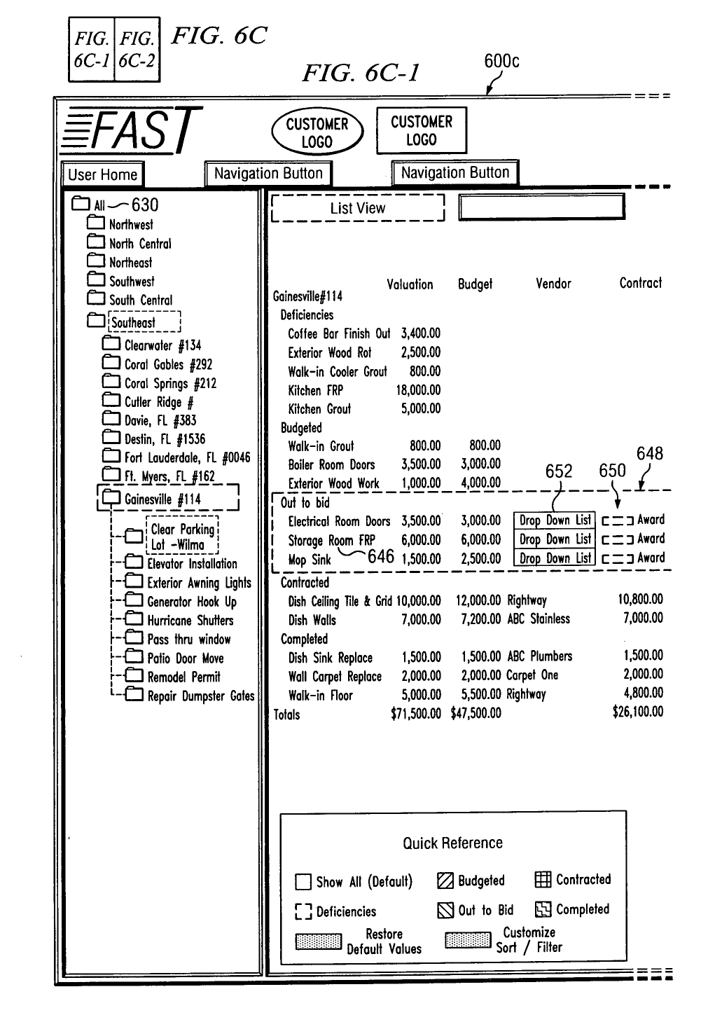

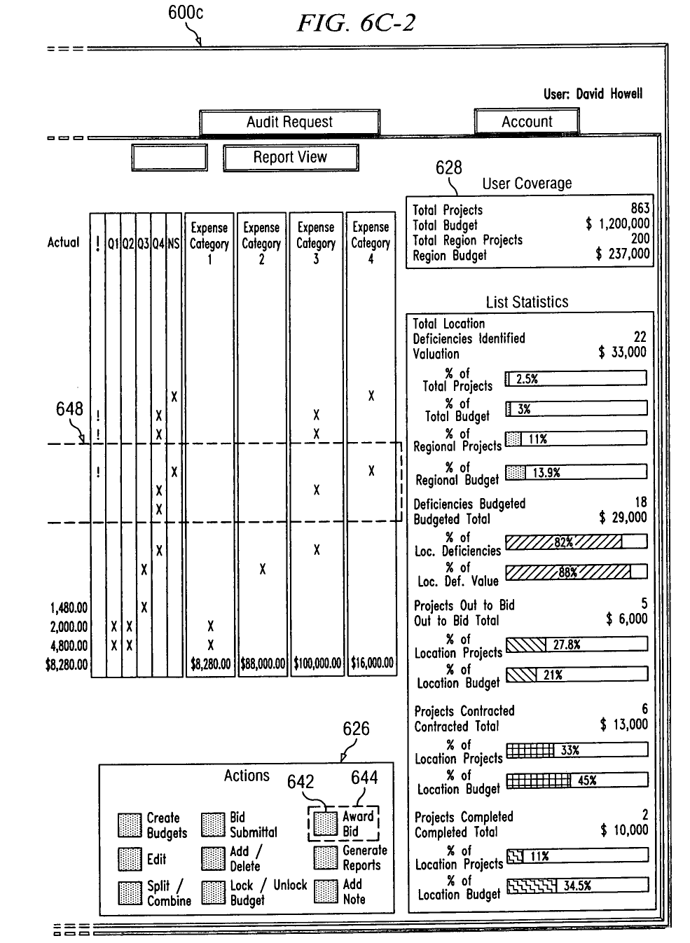

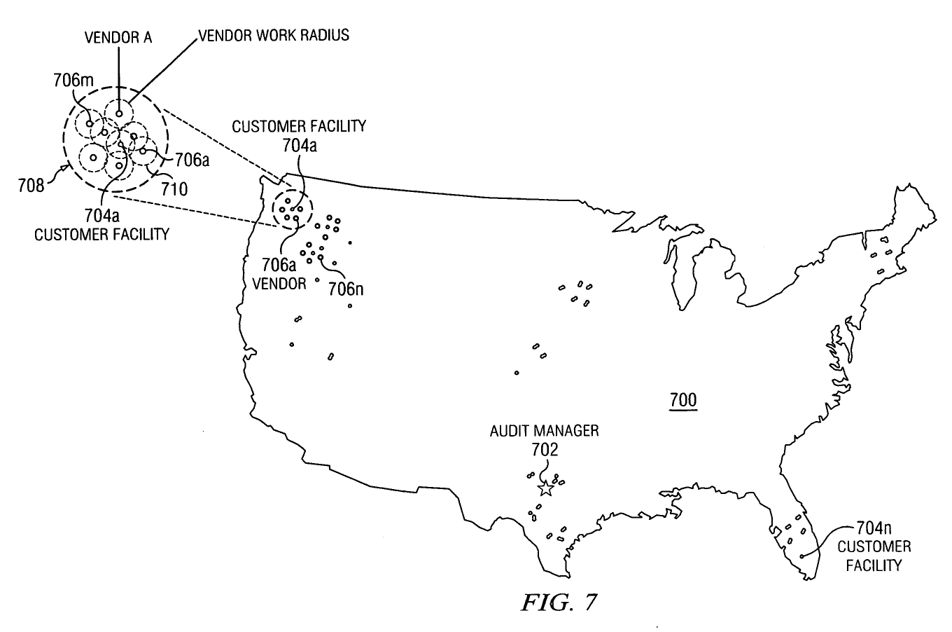

The actions manager module 512 may be a software module that is configured to enable a user to perform one or more actions on a graphical user interface. The actions may include creating budgets, editing information being displayed, splitting or combining facility information or site audit information of one or more facilities, submitting bids, adding and deleting facility or site audit information, locking and unlocking budgets, awarding bids, generating reports, and adding notes, as shown at the bottom of FIG. 6A. The actions manager module 512 may be configured as one or more software modules that enable a user to perform these functions. It should be understood that other actions may be provided for a user to perform for establishing facility information or working with site audit information collected during site audits.

The search module 514 is a software module that may be utilized to perform searches on information stored in one or more databases of facility information or site audit information. The search may be configured and performed as understood in the art to locate information that match one or more key entries. For example, a text entry field or other graphical user interface mechanisms may allow a user to enter one or more words that the user seeks to locate. For example, the user may enter the words “Coral Springs” for all facilities that are located within the town of Coral Springs or named Coral Springs, and the search results may be presented to the user. The user may select one or more of the search results to view additional information associated with those search results that match the search string.

The audit scheduler module 516 is a software module that may be configured to enable a manager to schedule site audits at customer facilities. The audit scheduler module 516 may present a graphical representation of a calendar showing dates and times and a manager may enter dates and times for auditors to perform site audits at one or more facilities. For example, the manager may schedule a site audit to be performed at a restaurant in Gary, Ind. on Jul. 14, 2007 and the auditor will receive that schedule information on his or her work schedule. The audit scheduler module 516 may automatically, semi-automatically, or manually communicate schedule information to an auditor via an e-mail message, hardcopy notice, instant message, or any other form of communication to the auditor being scheduled. Alternatively, the schedule may be created and a notice to all potential auditors in a local region for facilities that are to be site audited may be communicated to each of the available auditors. In addition, the audit scheduler module 516 may send notices to other personnel within the customer's organization and to other pertinent parties outside the customer, as well. It should be understood that the scheduler may have many different functions and features that are used for providing and managing schedules as understood in the art.

The custom query module 518 is a software module that may be used by an operator to perform custom queries of facilities that are to be or have been site audited. The custom queries may provide a number of options for a manager or user to view information associated with a facility. For example, a manager may select multiple facilities and the custom query module 518 may aggregate information associated with each of the facilities to present in a table or graphical format to the manager so that the manager can view a total amount of money to be used for repairing deficiencies at the selected facilities, for example. In one embodiment, the custom query module 518 may enable a user to select a region (e.g., town, city, state, northwest, country, etc.) of facilities of certain type formats (e.g., gas stations with convenience stores attached) and aggregate and/or statistical information associated with all facilities of the selected format and region may be presented to the user. Additional functions capable of being performed by the custom query module 518 are described further herein.

The database manager module 504 may include a number of different modules that are used for managing one or more databases and a customer audit server, such as customer audit server 302a of FIG. 4. The database manager module 504 may include a vendor list manager module 520, permission manager module 522, audit manager module 524, photo manager module 526, statistics generator module 528, facility graphical representation manager module 530, database backup manager module 532, and report generator module 534. These modules may be combined or further divided to provide the capabilities of managing one or more databases. Other and/or alternative software modules may be provided to perform the functions for managing information stored in databases or other data repositories.

The vendor list manager module 520 is software configured to manager vendor lists. The vendor lists may include lists of approved vendors provided by customers. The approved vendors may include general contractors, individual contractors, repair people, maintenance people, or other vendors who may perform repair or replacement services of parts, equipment, and systems at facilities. In addition, the vendor lists may include locations and other contract information of the vendors, geographical regions within which a vendor will work radius distance from location of a vendor within which a vendor will work, or any other information associated with the vendor and/or customer to allow the customer audit server and/or enable a user to determine which vendor(s) to communicate requests for proposals to repair or replace deficiencies located at one or more facilities of the customer. Still yet, the vendor lists may include information of scope of work that each vendor is willing to take a job. For example, a tile contractor may perform repairs of $5,000 or more or a contractor may limit receiving RFPs to repairing tile in areas of 200 square feet or more. Alternatively, a vendor may be limited to working certain times, such as daytime. In one embodiment, a sponsored vendor list may be included as a list of vendors, where a sponsored vendor list is one for which each vendor on the sponsored vendor list pays a fee, such as a daily, weekly, monthly, or annual fee to be listed. Vendors on the sponsored vendor list may alternatively pay a commission for each RPF received or on a successful job hire.

The permission manager module 522 is a software module configured to manage access to facility information or site audit information by users of the custom audit server. The permission manager module 522 may be configured to allow a manager to view all information, while an auditor may access facility information and site audit information on facilities that he or she has been assigned to site audit. Still yet, a store manager may be limited to view only information associated with his or her store. It should be understood that permissions may be provided to enable different users to access different levels of information as understood in the art.

The audit manager module 524 is a software module that may be configured to manage site audit information collected from site audits of facilities. The audit manager module 524 may be configured to manage storage, updates, alterations, statistics information of site audits, aggregation information or site audits, and any other information associated with a site audit.

The photo manager module 526 is a software module that may be utilized to manage photographs associated with site audits that are performed by auditors at facilities. The photographs may be stored in such a manner that links, such as reference indicia, hypertext, or otherwise, may be used to determine location of photographs stored in a database. The photo manager module 526 may automatically organize photographs taken at a particular facility into a specific location within a database or other data repository, such that the photographs may be automatically stored and accessed by a user, such as an auditor, who uploads photographs of a facility taken during a site audit and view the site audit information after the site audit.

The statistics generator module 528 is a module that enables a user to generate statistics associated with facility information and/or site audit information. The statistics generator module 528 may generate the statistics automatically or in response to a request from a user to generate specific statistics. The statistics generated may be stored in association with the facility information and/or site audit information. Alternatively, the statistics information may be stored separately from the information from which the statistics were generated. The statistics generator module 528 may further be configured to generate aggregation information in response to a user selecting multiple facilities to aggregate site audit information or budget information, for example. It should be understood that this statistics generator module 528 may perform any mathematical computation on any information available within a database accessible by the customer audit server.

The facility graphical representation manager module 530 is a software module that may be configured to generate and manage facility graphical representations of facilities that are to be audited. The facility graphical representations may include any graphical representation, such as plan layouts, floor plans, elevations, overhead views, photographs, or any other graphical representation that maybe used during a site audit to identify locations of deficiencies at a facility.

The database backup manager module 532 is a software module that may be utilized to perform automatic, semi-automatic, or manual backups of databases at or in communication with the customer audit server. The database backup manager module 532 may back the databases up onto a remote server or database using complete backups, or partial backups to update only information that has been added to the database since the previous backup.

The report generator module 534 is a software module that may be configured to generate reports for users of the customer audit server. The report generator module 534 may generate reports using facility information and site audit information and provide a report in any format. The report generator module 534 may also access the information generated by the statistics generator module 528, photos managed by the photo manager module 526, or any other information stored or accessible by the customer audit server. The report generator module 534 may have predefined reports and be capable of enabling a user to define reports in any other format or include any parameter or information on the report.

The database manager module 504 may include the software modules described above in any combination and include other software modules not listed. The databases may include customer, facility, and site audit information as provided in the below exemplary list:

| 1) | Client Specific | |
|---|---|---|
| | a) | Business Type (Industry) |
| | b) | Parent Company |
| | c) | Concept |
| | d) | Prototype |
| | e) | Client Specific Region |
| | f) | Facility manager |
| | g) | Other Personnel |
| | h) | Predetermined budget Amounts for each repair item |

| | |
|---|---|
| 1. | Ceiling tile per sq. ft. |
| 2. | Floor tile per sq. ft. |
| 3. | Base tile per linear ft. |
| 4. | FRP per sheet |
| 5. | Stainless Steel per sheet |
| 6. | Corner guards each |
| 7. | Grout per square foot |

| | |
|---|---|
| i) | Priority levels |
| j) | Repair classification (Based on type and/or |
| | cost determined by client) |

| | |
|---|---|
| 1. | Repair and Maintenance |
| 2. | Remodel Cost |
| 3. | Furniture Fixtures and Equipment Cost |
| 4. | Facility Project |
| 5. | Capital Expense |

| | |
|---|---|
| k) | Priority Levels |

| | |
|---|---|
| 1. | Dollar amounts |
| 2. | Type of repair |

| | |
|---|---|
| i. | Safety |
| ii. | Appearance |
| iii. | Preventative |
| iv. | Safety |
| v. | Health |
| vi. | Upgrade |

| 2) | Site Specific | |
|---|---|---|
| | a) | General |

| | |
|---|---|
| 1. | Time and date of auditor |
| 2. | Name of auditor |
| 3. | Age of facility |
| 4. | Demographic info |

| | |
|---|---|
| i. | Address |
| ii. | Mapquest ® website link and/or Mapsco ® map page |
| iii. | Manager |
| iv. | Other personnel |

| | |
|---|---|
| 5. | Weather |

| | |
|---|---|
| i. | General Description (Temperature, rain, sun, |
| | partly cloudy, snow, windy, etc.) |

| | |
|---|---|
| b) | Fire Prevention |

| | |
|---|---|
| 1. | Suppression equipment |
| 2. | Extinguishers |
| 3. | Sprinkler system |
| 4. | Exits |
| 5. | Signage |

| | |
|---|---|
| c) | Equipment |

| | |
|---|---|
| 1. | HVAC |
| 2. | Water Heater |
| 3. | Exhaust Fans |
| 4. | Refrigeration |
| 5. | Manufacturer |
| 6. | Model #'s |
| 7. | Serial #'s |
| 8. | Type of Equipment |

| | |
|---|---|
| i. | HVAC |
| ii. | Exhaust Systems |
| iii. | Cooking Equipment |
| iv. | Furniture and Fixtures |
| v. | Small appliances |
| vi. | Hoods |

| | |
|---|---|
| d) | Manager Interview |

| | |
|---|---|
| 1. | On going problems |

| | |
|---|---|
| i. | Plumbing |
| ii. | HVAC |
| iii. | Refrigeration |
| iv. | Electrical |
| v. | Safety (Slip and falls . . . ) |
| vi. | Water infiltration (leaks from roof, plumbing . . . ) |
| vii. | Equipment problems |

| | |
|---|---|
| (a) | excessive repairs |
| (b) | Not functioning properly . . . |

| | |
|---|---|
| e) | Areas |

| | |
|---|---|
| 1. | Site |

| | |
|---|---|
| i. | Landscape |
| ii. | Parking lot |

| | |
|---|---|
| (a) | Type |
| (b) | Striping |

| | |
|---|---|
| (i) | Wheel stops |

| | |
|---|---|
| iii. | Fencing |
| iv. | Lighting |
| v. | Signage |
| vi. | Sidewalks |

| | |
|---|---|
| 2. | Structures |

| | |
|---|---|
| i. | Main |

| | |
|---|---|
| (i) | Roof |
| (ii) | Paint |
| (iii) | Doors |
| (iv) | Windows |
| (v) | Lighting |
| (vi) | Gutters |

| | |
|---|---|
| ii. | Dumpster areas |
| iii. | Other structures |

| | |
|---|---|
| (i) | Similar parameters as main |

| | |
|---|---|
| 3. | Interior |

| | |
|---|---|
| i. | Front of house (FOH) |

| | |
|---|---|
| (i) | Client defined, but, for example: |

| | |
|---|---|
| a. | Dining areas |
| b. | Waiter stations |
| c. | Lobby |
| d. | Restrooms |
| e. | To go area |
| f. | Bar and areas within |

| | |
|---|---|
| ii. | Back of house (BOH) |

| | |
|---|---|
| (i) | Client defined, but, for example: |

| | |
|---|---|
| a. | Kitchen areas |

| | |
|---|---|
| 1. | Coolers |
| 2. | Dish areas |
| 3. | Employee Restrooms |
| 4. | Cooksline |
| 5. | Prep line |
| 6. | Server alley |
| 7. | Other areas |

The communications manager module 506 may include a download manager module 536, upload manager module 538, subscriber manager module 540, RFP distribution manager module 542, firewall manager module 544, and software package data translator module 546. Other software modules may also be included for performing operations of communications to and from the customer audit server. The software modules may also be combined or further refined to provide the same or similar functions.

The download manager module 536 is a software module that is configured to provide download capabilities of facility information and/or audit information by an auditor to a handheld computing device. The download manager module 536 may keep track of the facility information downloaded by an auditor and prevent other auditors from downloading the same information. The download manager module 536 may also be configured to assign facility information to particular auditors having access to certain facility information, thereby minimizing sharing of data or access to information by auditors. The download manager module 536 may also be configured to automatically distribute the facility information to auditors at predetermined times prior to a site audit being scheduled by the audit scheduler module 516.

The upload manager module 538 is a software module that may be configured to enable an auditor to upload site audit information generated during a site audit at a facility. The upload manager module 538 may operate in conjunction with one or more database manager modules to store the site audit information within one or more databases. The upload manager module 538 may be configured to automatically, semi-automatically, or manually perform uploading of site audit information generated during an site audit of a facility.

The subscriber manager module 540 is a software module that maybe configured to manage subscribers of the customer audit server. The subscriber manager module 540 may manage lists of subscribers, including user names and passwords, addresses, and any other information associated with subscribers who may desire to access information, such as aggregated site audit information, generated by site audits of facilities. The subscriber manager module 540 may manage the types of information to which a subscriber has access. The subscriber manager module 540 may also maintain lists and perform functions to communicate site audit information or facility information to subscribers on a periodic or non-periodic basis the electronic communications or otherwise.

The RFP distribution manager module 542 is a software module that is configured to manage RFP distribution to potential vendors who are available to perform repairs or replacements of items at a facility. The RFP distribution manager module 542 may manage or access information of vendors managed by the vendor list manager module 520 and communicate RFPs to those vendors who are within range, capable and/or available to work on a particular facility, or meet any other criteria, such as size of jobs that a particular vendor is willing to handle.

The firewall manager module 544 is a software module that operates to prevent unauthorized users to access the customer audit server or any database stored therein or in communication therewith. The firewall manager module 544 may operate as any firewall as understood in the art.

The software package data translator module 546 is a software module that is configured to translate data, such as the facility information or site audit information that is stored in a database of the customer audit server. The translation may translate the format of the data into any format that a different software package can access. For example, the site audit information may be converted to a format that a software product, such as Microsoft Excel®, can read.

FIGS. 6A-6B are screenshots of exemplary graphical user interfaces 600a-600c for enabling a manager to perform budgeting and contracting of repairs on deficiencies of facilities that have been site audited. FIG. 6A is an exemplary graphical user interface or GUI 600a that may be used by a user of a customer audit server, such as customer audit server 302a of FIG. 3. The GUI 600a may be driven by the GUI manager module 502 and modules operating therein.

The GUI 600a may include a header 602 that includes one or more logos identifying the software and customers that the GUI 600a is operating to serve. The header 602 may also identify the developer or developers of the software.

The GUI 600a may also include a number of soft-buttons 604 that extend across the GUI 600a. The soft-buttons 604 may include a user home soft-button 606, navigation soft-button 608, second navigation button 610, audit request soft-button 612, and account soft-button 614. The first and second navigation soft-buttons 608 and 610 may be predefined or defined by a user to navigate to a particular link for a user to access. The audit request soft-button 612 may link a user to a webpage that enables the user to request a site audit to be performed. The account soft-button 614 may link the user to another screen that enables the user to perform account functions, such as entering new users, managing existing users, setting up passwords, or perform other account functions. The user who has logged into the system to access the graphical user interface 600a may be displayed in a user field 616.

The GUI 600a may include a number of different regions within the GUI, including a navigation region 618, view region 620, and statistics region, 622. In addition, a quick reference region 624 and actions region 626 may be provided to enable a user to quickly understand certain characteristics and/or indicia being displayed on the GUI 600a and perform actions or functions on data being managed by the customer audit server and displayed on the GUI 600a. It should be understood that the regions shown on the GUI 600a are exemplary and that other and/or alternative regions maybe displayed depending upon the view and permissions of the user.

The navigation region 618 may include a graphical hierarchical display of facilities being managed by an operator or owner of the facilities. As shown, the navigation region 618 includes a number of different file folders 628 with associated names of regional areas or regions (e.g., Southeast) and individual facilities contained within the regional areas (e.g., Gainesville #114). As another example, a file folder entitled “All” 630 indicates a master folder under which all facilities owned or operated by a customer reside. File folders 632 are identified as different regional areas throughout the United States. For example, the folders are entitled “Northwest,” “North Central,” “Northeast,” “Southwest,” “South Central,” and “Southeast.” Each of these file folders may be selectively opened by a user to expand the contents of the file folder to show individual facilities within each regional area. For example, the file folder 634 identified as “Southeast” is opened to show nine different stores within the Southeast regional area. Each of these stores have an associated file folder that may also be selected or selectively opened by the user to view contents therein. For example, file folder 636 is selected, as indicated by a highlighted box 638 surrounding the file folder and identifier, and a list of areas shown as file folders 640 of the facility, identified as “Gainesville #114,” are displayed. The areas are areas at the Gainesville #114 store. For example, the areas include a clear parking lot, elevator installation, exterior awning lights, generator hookup, hurricane shutters, pass-through window, patio door move, repaired dumpster gates. In addition, a remodel permit file folder 642 is listed as information associated with requesting a remodel permit may be associated with a site audit of the Gainesville #114 facility. The navigation region 618 may use alternative navigation tools. However, using file folder listings is well understood by users of computers, so little learning curve is presented to users of the GUI 600a.

The view region 620 may include a list formatted as a chart. The list may be used for creating budgets of deficiencies found at the Gainesville #114 facility, which is currently selected as indicated by the highlighted box 638. The deficiencies that need to be budgeted may include a name, such as “coffee bar finish out,” a valuation, which is indicative of the cost of repair, and budget that the customer would like to spend on the repair or replacement of the deficiency. A number of columns may be provided such that the user may select or enter information to be included in each column associated with each deficiency. For example, the columns may include “valuation,” “budget,” “vendor,” “contract,” “actual,” “exclamation point,” “Q1,” “Q2,” “Q3,” “Q4,” “NS,” “expense category 1,” “expense category 2,” “expenses category 3,” and “expense category 4.” Each of these columns may receive a selection or entry by a user to indicate information associated with repairing or replacing a deficiency. The vendor, contractor, and actual columns may be selected or filled in by a user who is looking to select one or more vendors, award a contract, and provide actual completion dates for fixing or repairing the deficiencies. The “exclamation point” is an indicator that a user may select by pressing a “radio-button” graphical interface element to indicate that a deficiency is high priority to complete. A user may select a quarter (e.g., Q1-Q4) that the deficiency should be repaired or replaced. The “NS” column indicates that the deficiency has no schedule associated for completion. Furthermore, the user may select a radio-button for indicating a particular expense category to which the repair or replacement of the deficiency is to be assigned. For example, if the deficiency is a piece of equipment, then a user may select to put the repair or replacement of the deficiency into an equipment expense category. It should be understood that the listing of expense categories may include four or more. It should further be understood that the use of radio-buttons may be provided as drop-down menus or any other graphical user interface element that enables a user to enter information associated with repairing or replacing a deficiency.

As shown, the information may be accumulated into a “totals” 644 row that totals the amount of money listed in each of the columns. For example, valuation of all the deficiencies to be completed is $71,500. The expense categories may also be totaled to include those items listed in the current view for the Gainesville #114 facility plus all other facilities in a particular expense category. By accumulating the total values, a user or manager may be able to quickly determine budgets and other information for repairing or replacing deficiencies in the currently selected facility, deficiencies by expense categories, and/or otherwise.

The quick reference region 624 may show a variety of indicia, such as shapes, patterns, colors, or otherwise, that help a user identify certain aspects of the GUI 600a. For example, the quick reference region may show a list of elements, including “show all (default),” “deficiencies,” “budgeted,” “how to bid,” “contracted,” “completed,” “restore default values,” and “customize sort/filter.” Each of these indicia may be indicative of status of repair or replacement of one or more deficiencies and be selectively changed by a user to change color or shape, for example. In addition, these indicia maybe selectable as soft-buttons to, for example, restore default values.

The actions region 626 may include a number of selectable actions or functions to be performed on the GUI 600a. For example, the actions may include “create budgets,” “edit,” “split/combine,” “bid submittal,” “add/delete,” “lock/unlock budget,” “award bid,” “generate reports,” and “add note.” The actions shown are exemplary and additional or alternative actions may be provided in the actions region 626. The user may select an action, such as “create budget,” to perform that action. The current view region 620 is selected to enter or create budgets for deficiencies of a facility selected by the user. Once the budgets are submitted, the user may select the lock budgets soft-button shown in the actions region 626.

The statistics region 622 may include one or more regions showing statistics of the information shown in the view region 620. For example, a user coverage region 628 may include totals of various categories, such as total number of projects, total budget, total region projects, and region budget. A statistics list region 630 may include a variety of statistics of valuation, budgets, bids, contracts, and completed projects for repairing or replacing deficiencies of facilities in one or more regions as selected by the user.

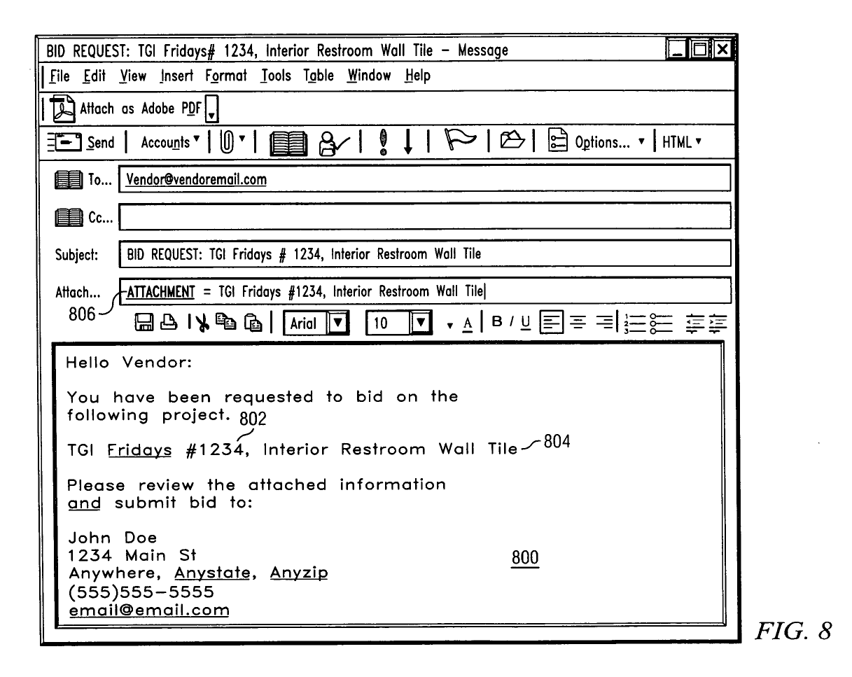

FIG. 6B shows another exemplary GUI 600b that enables the user to generate bid submittals or requests for proposals (RFPs) by the user selecting a bid submittal soft-button 632 in the actions region 626. The view region 620 displays a highlighted box 634 around the bid submittal soft-button 632 to indicate that the action currently being conducted is a bid submittal. Another highlighted box 636 highlights deficiencies that have been budgeted that need vendor selection for performing repair of the deficiencies. Each deficiency may have a drop-down list 639, for example, that enables a user to select vendors from an approved vendor list and/or vendors capable of performing the repairs of the deficiencies at the selected facility indicated by a highlighted box 638 around the Gainesville #114 indicia identified by the file folder 636. The user may select one or more vendors from the drop-down list 639 and, upon completion, select a send soft-button 640 to send a communication to a selected vendor or vendors. Alternatively, the list of potential vendors to repair the deficiency may be selectable from a pop-up window (not shown) and the user may highlight or select a selectable element (radio button) to select the potential vendor(s) to send an RFP. Alternatively, rather than providing the user with the list of vendors from which to select, the user may set one or more pre-established vendors to send the RFP for certain types of deficiencies to repair. Still yet, the software may be configured to automatically send RFPs based on customer and/or vendor criteria. In another embodiment, the software may be configured to send RFPs to vendors to pay for a vendor subscription to send RFPs that meet certain vendor established criteria. The communication may include an e-mail (FIG. 8) or other communication that may be delivered to or accessed by each of the vendors selected by the user.

Continuing with FIG. 6B, the drop-down lists 639 may include only vendors that have been determined to work at the customer facility because it is within a geographical radius or region that the vendor is willing to work. Alternatively, a listing of vendors, even those not indicated as willing to work at the location of the customer facility, maybe listed in case the vendor is willing to make an exception for a particular job. In addition, the vendor list may be determined by vendors who are willing to work on a repair of a deficiency for a minimum and/or maximum value. Vendors who the budgeted repair value that meets the criteria of the vendor may be listed in the drop-down list 639. There may be a minimum or maximum monetary threshold pre-established by a vendor who may have access to the system or customer who has a relationship with vendors in the region surrounding the facility. Alternatively, the audit manager 102 may have a list of vendors located across the country and manage a database of vendors that has set certain criteria, including a geographical coverage, such as radius and specific cities or regions, specific job values or monetary thresholds, specific customers, or any criteria that may be considered by a vendor to or not to repair a deficiency at a vendor facility. Each vendor may additionally be categorized to work on certain types of deficiencies, for example, doors, windows, equipment, system, etc.

FIG. 6C is a screenshot of an exemplary GUI 600c showing an action to award a bid to a vendor who has submitted a bid in response to receiving an RFP for repairing a deficiency. As shown, the action region 626 has bid award soft-button 642 highlighted by a highlighted box 644. The deficiencies 646 shown in a highlighted box 648 may provide soft-buttons 650 that enable a user to award bids to one or more vendors who have submitted bids using drop-down lists 652. The drop-down lists 652 may list bidders who have submitted bids for a user to select to send a bid award by selecting the bidder and then a soft-button associated with the deficiency. Rather than using a drop-down list 652, other graphical user interface functions or elements, such as pop-up windows, check lists, radio buttons, or otherwise, may be utilized to enable a user to select to send a bid award to a winning bidder.

FIG. 7 is an illustration of an exemplary map 700 showing customer facilities and vendors available to repair deficiencies within the customer facilities. The map 700 may show location of an audit manager 702 represented by an indicia, such as a star, that operates to manage the GUI. Alternatively, the indicia 702 may be indicative of the customer headquarters. Each customer facility 704a-704n may be identified by an indicia, such as a filled in circle, and each potential vendor 706a-706n may be a different indicia, such as an open circle. Exploded view 708 shows a customer facility 704a and potential vendors 706a-706m that are potential vendors for the customer facility for facility 704a. However, each potential vendor may have a selected work radius or other region identified by dashed lines 710 encircling each vendor. The vendors may be willing to work on a facility within a radius identified by the dashed lines 710. As shown, vendor 706m is not within the radius of the vendor, and, therefore, the potential vendor 706m may be unwilling to work on the customer facility 704a. The potential vendors 706a-706m may be shown on the map 700 on a GUI that may be zoomed-in and zoomed-out. In one embodiment, rather than showing map 700, the GUI may display a list or select the potential vendors 706a-706m that are potential vendors without displaying the vendors.

FIG. 8 is a screenshot of an exemplary e-mail 800 communicated to a potential vendor for repairing deficiencies within a facility of a restaurant. As shown, the e-mail 800 includes facility information 802 and deficiency information 804 so that a vendor may have an understanding of a job to repair the deficiency. The deficiency information 804 may include a title and specific description as to the type of material, size of area to be repaired, and any other information, such as color, texture, or otherwise, of the deficiency for repair. The information may further include an attachment 806 that the vendor may open that shows site audit information, including photographs, notes, areas, floor layout, or any other information that may help a vendor determine a bid for repairing the deficiency. The email 800 may additionally and/or alternatively include an attachment of a specific bid form of a customer for the vendor to prepare and submit. Alternatively, the e-mail 800 may include a link to an RFP management system that the vendor already uses other than a customer audit server used by a customer. Alternatively, rather than sending an attachment in the e-mail 800, a hyperlink may be provided in the e-mail 800 that allows the vendor to link into the software system of the customer audit server to access the site audit information, thereby providing the vendor the ability to understand the deficiency that needs to be repaired and, optionally, submit a bid directly within the audit management server. It should be understood that rather than sending the e-mail 800, that any other notification or communication may be provided to the vendor indicating that an RFP is available and for the vendor to submit a bid in response to receiving the RFP.

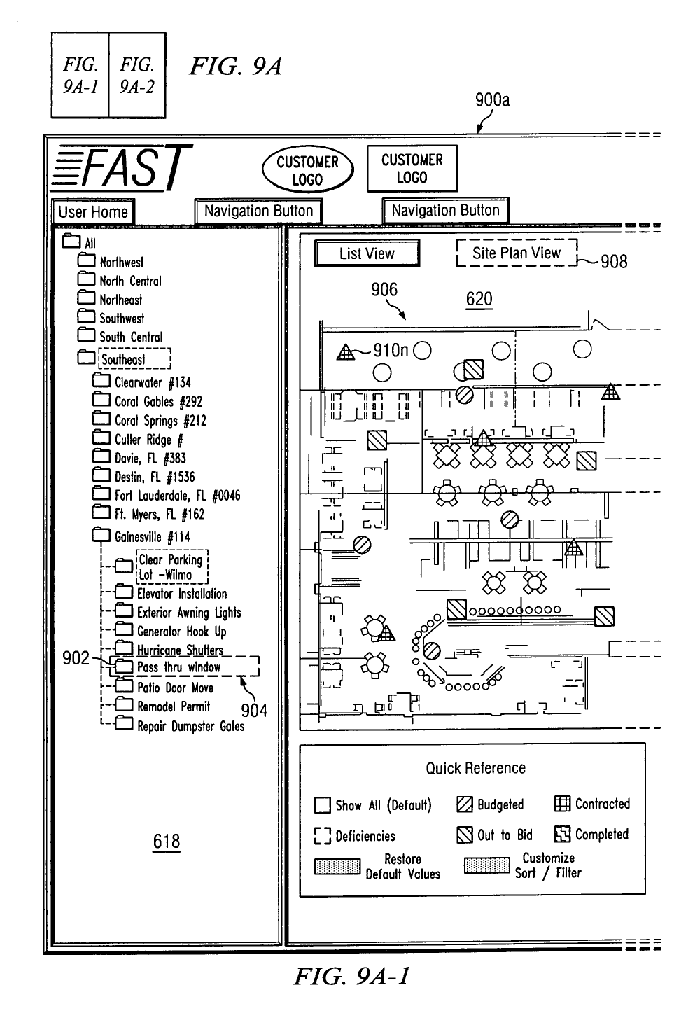

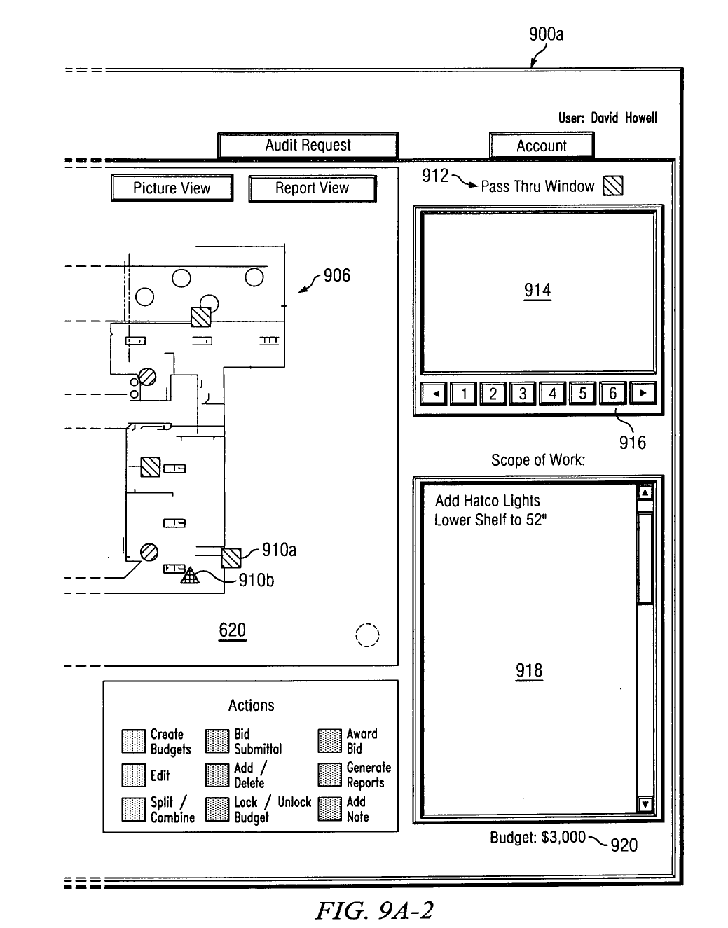

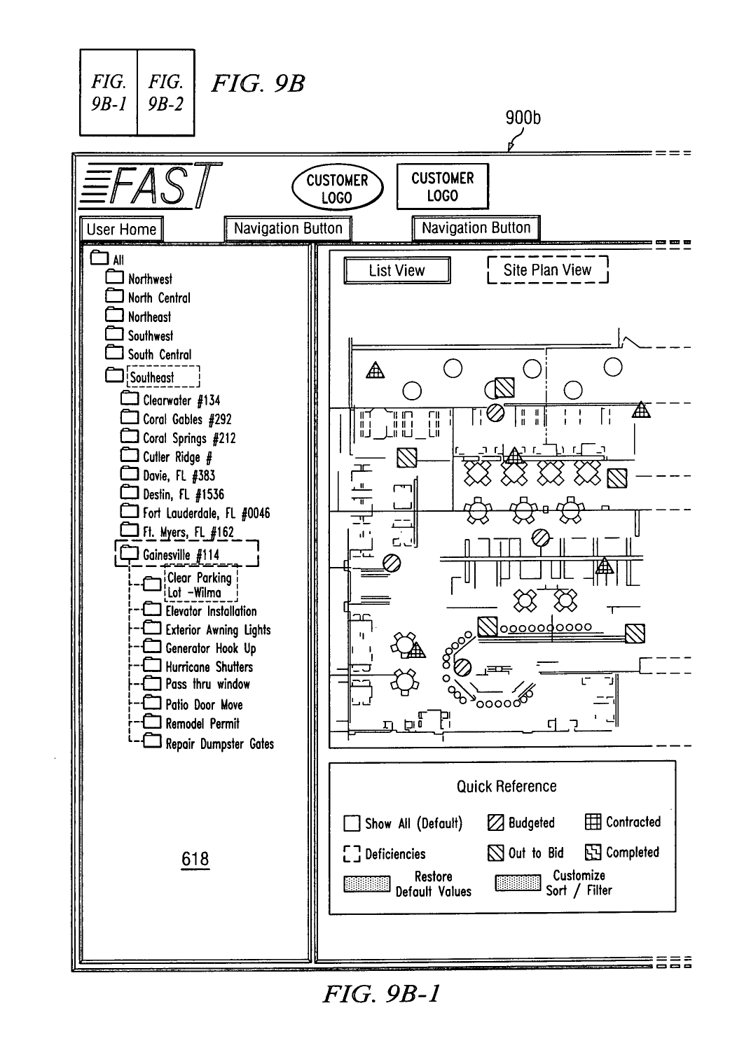

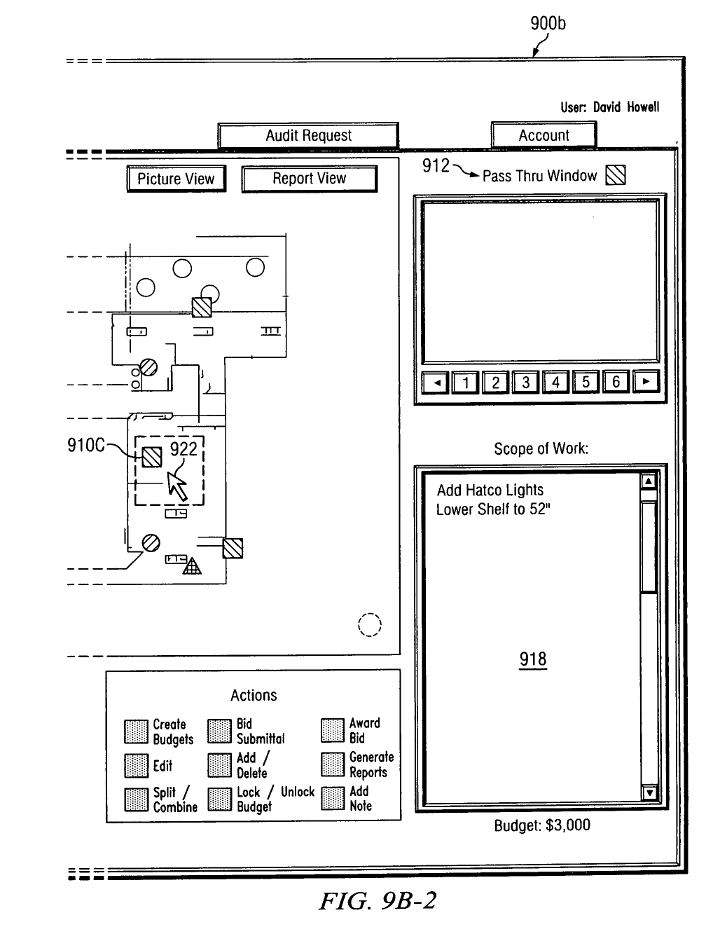

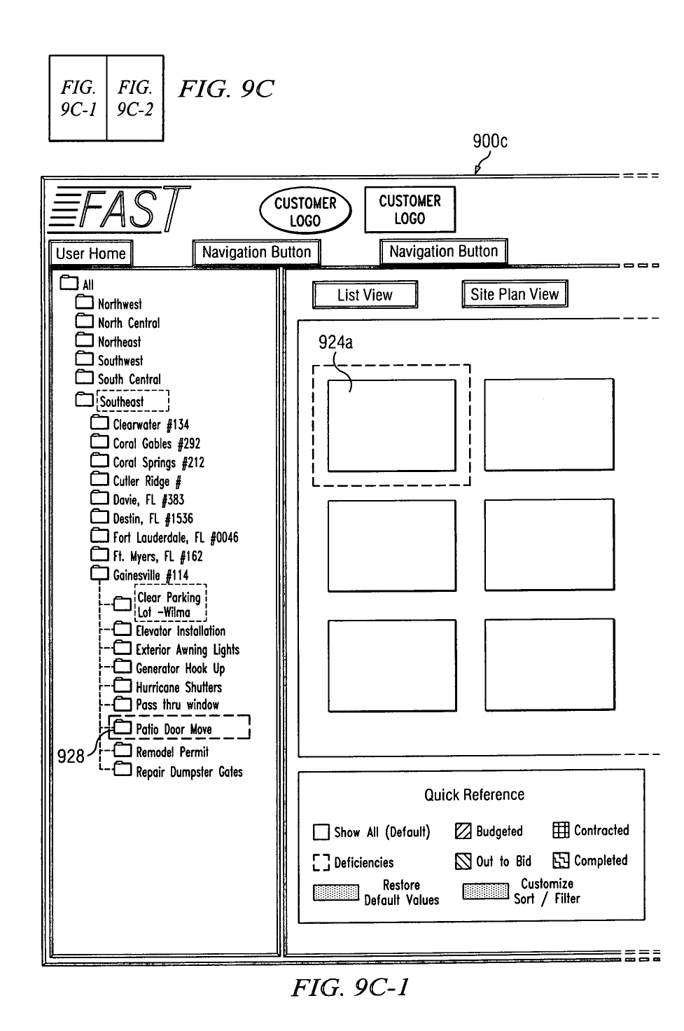

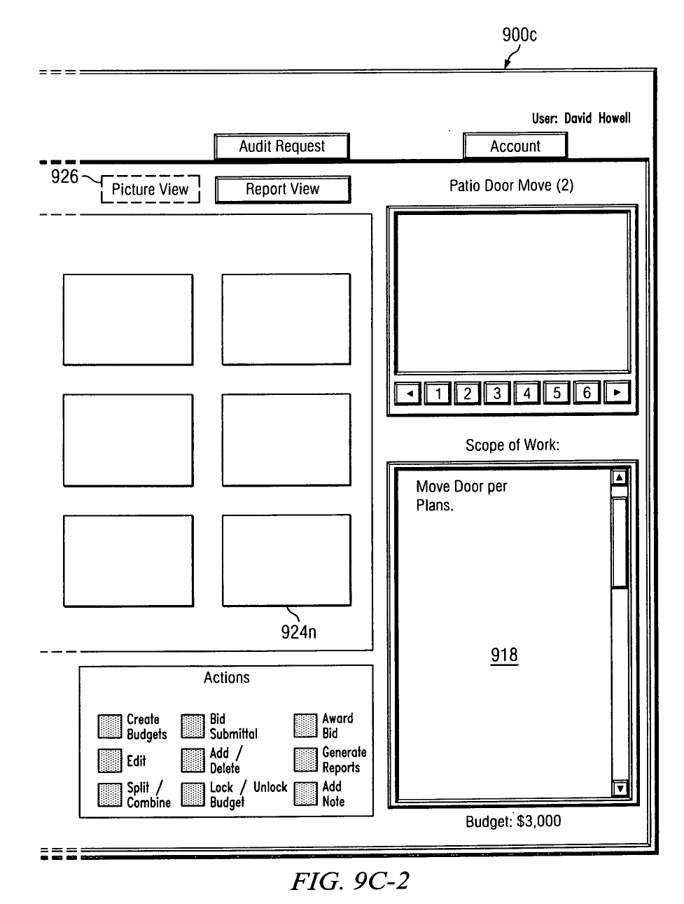

FIGS. 9A-9C are screenshots of exemplary graphical user interfaces showing site plan views and picture views of a facility of a chain of restaurants. FIG. 9A is a screenshot of an exemplary GUI 900a that operates in the same or similar manner as the GUI 600a of FIG. 6A. The navigation region 618 shows the same information as was shown in FIG. 6A, but a file folder 902 identified by “pass-through window” has been highlighted as indicated by highlighted box 904. The pass-through window is an area within the Gainesville #114 facility that has been identified to include a deficiency. The view region 620 shows a site plan 906 in response to a site plan view soft-button 908 being selected by the user. The site plan 906 shows a number of different indicia having different shapes and colors indicative of deficiencies at the selected facility. The indicia, such as indicia 910a-910n, may have different colors, shades, patterns, geometric shapes, or otherwise so that a user may easily identify deficiencies and current status of each deficiency. For example, a deficiency that is a triangle showing the color green or having a certain pattern or shade, such as deficiency 910b, may indicate that the deficiency has been contracted. A square indicia, such as deficiency 910a, may indicate that an RFP has been sent to vendors and is currently out to bid. It should be understood that many different types of indicia may be associated with deficiencies and the different deficiencies may have different indicia.

Rather than including a statistics region, such as statistics region 622 of FIG. 6B, an area region 912 may show the area selected by a user including one or more photographs 914 of the area that show deficiencies determined during a site audit by an auditor of the area of the facility. A user may select one or more photographs to view using soft-buttons 916. In addition, a scope of work area 918 may include notes prepared by an auditor of deficiencies during the site audit. The notes may include a problem and solution or work to be performed to correct the deficiency. Furthermore, a budget 920 may be identified in association with the deficiency. The budget 920 may be determined based on site audit information collected by an auditor during a site audit. For example, if the auditor determines that 150 square-feet of tile is determined to be replaced, the system may perform an initial budget calculation of the area of tile, type of tile, and cost of tile. A user may override the initial budget calculation by the system. In the event that a deficiency cannot easily be determined by an auditor, such as an unpleasant odor, a budget may be determined by a user, such as a budget manager, post-site audit.

FIG. 9B is a screenshot of another exemplary GUI 900b that shows a pointer indicia 922 pointing to a deficiency indicia 910c associated with the area selected by the user. In this case, the pointer indicia 922 is selecting the deficiency indicia 910c associated with the pass-through window and information of the pass-through window is provided in the scope of work region 918, etc.

FIG. 9C is a screenshot of an exemplary GUI 900c that is showing photographs 924a-924n of a facility in response to a user selecting a picture view soft-button 926. In this case, the user has also selected a file folder 928 to identify an area, “patio door,” and deficiency for that area. In this case, the photograph 924a, which is a thumbnail of a photograph, highlights the patio door and the scope of work region 918 indicates that the door is to be moved per plans. Other photographs associated with the selected area (i.e., patio door) are provided in the area region 912.

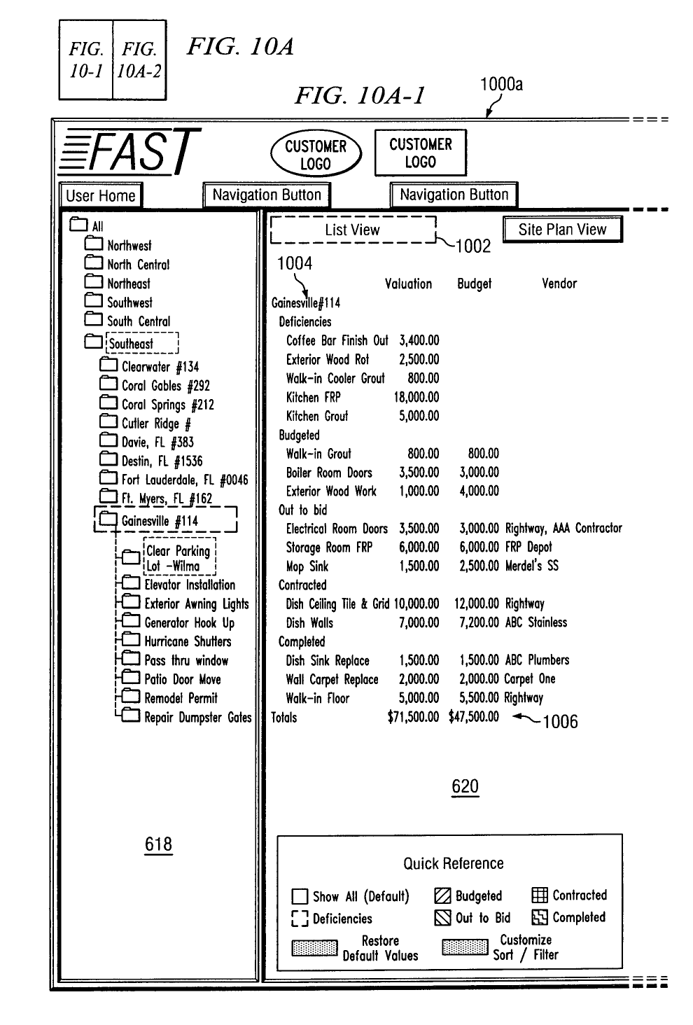

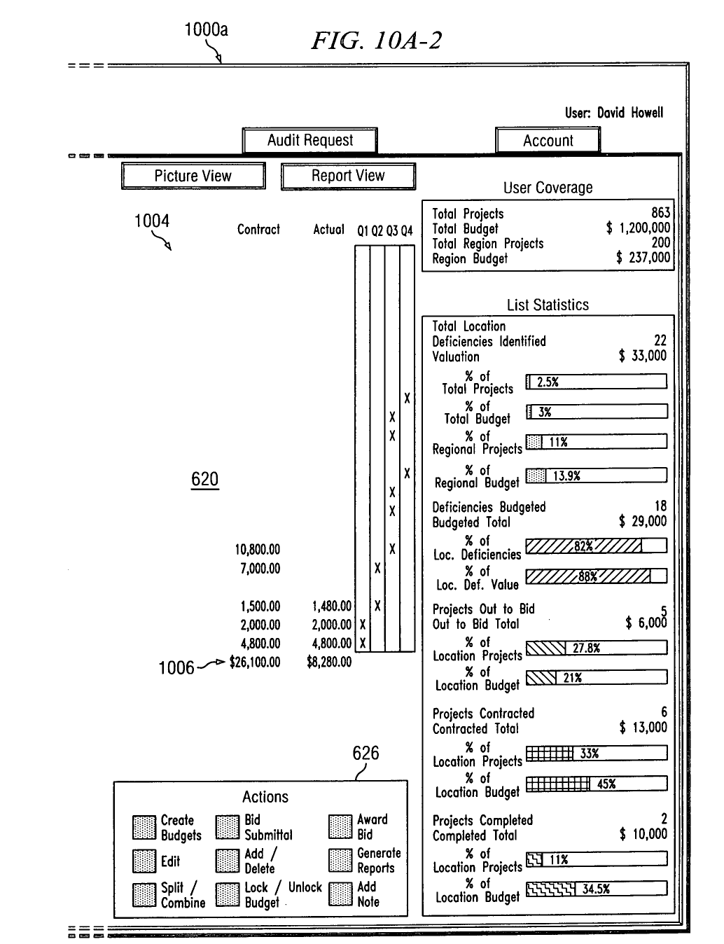

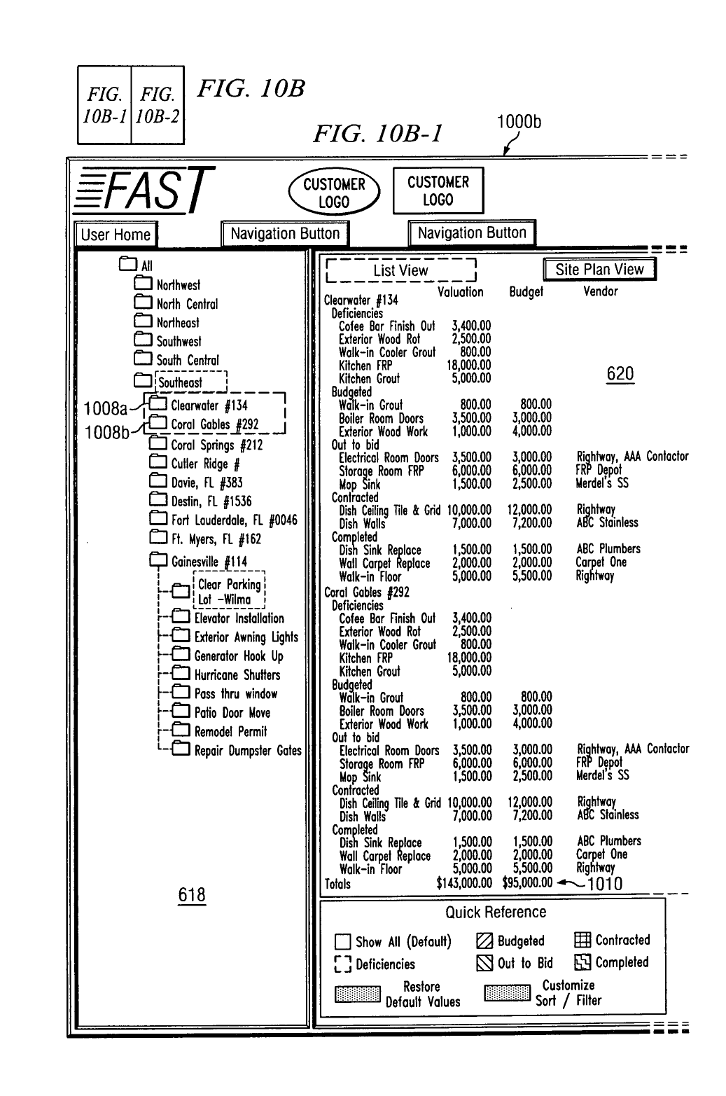

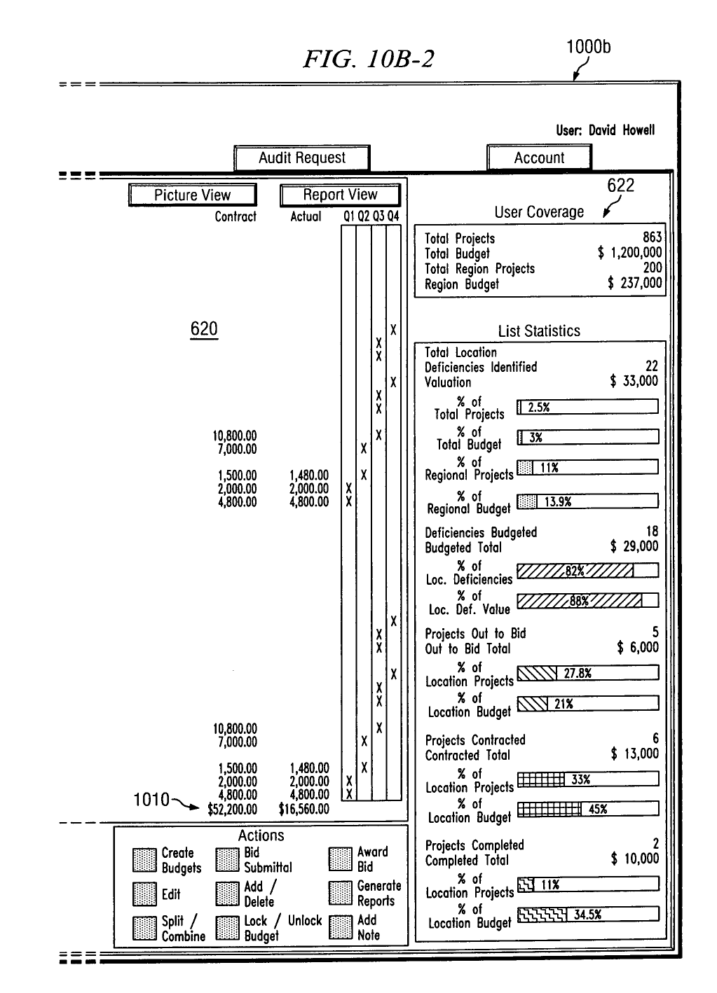

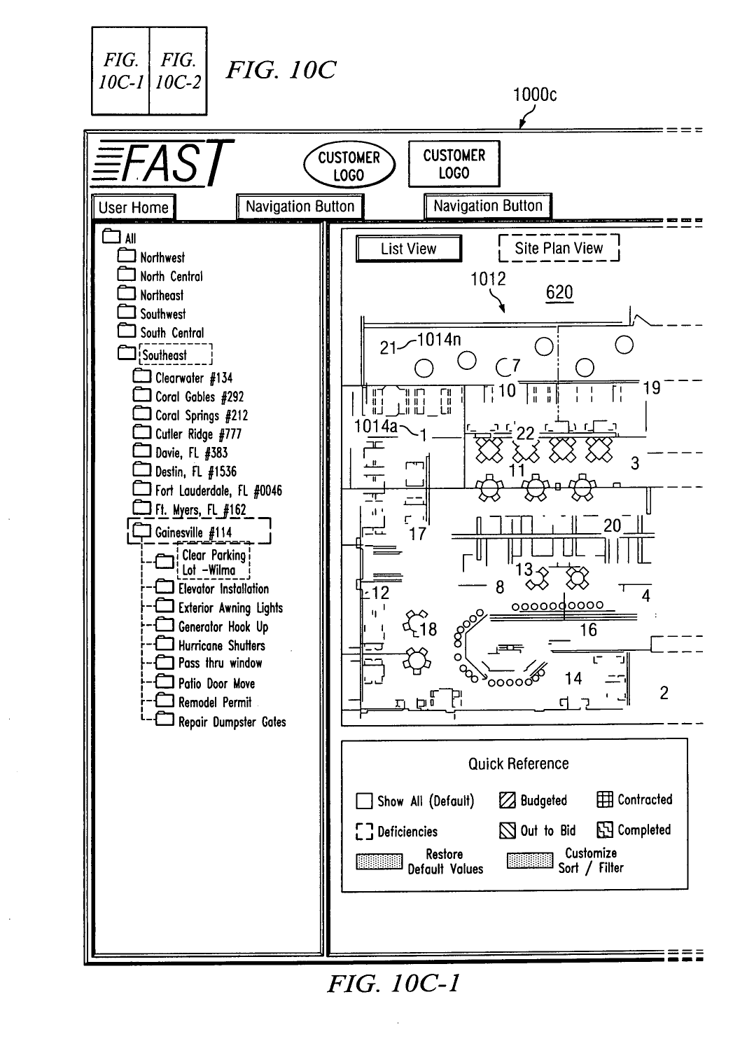

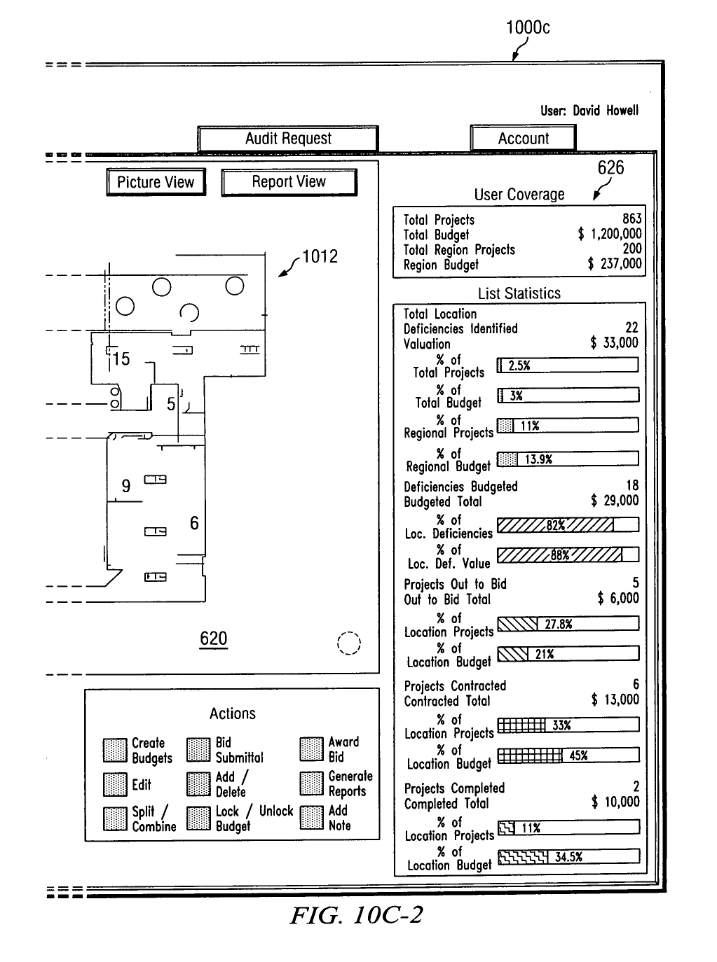

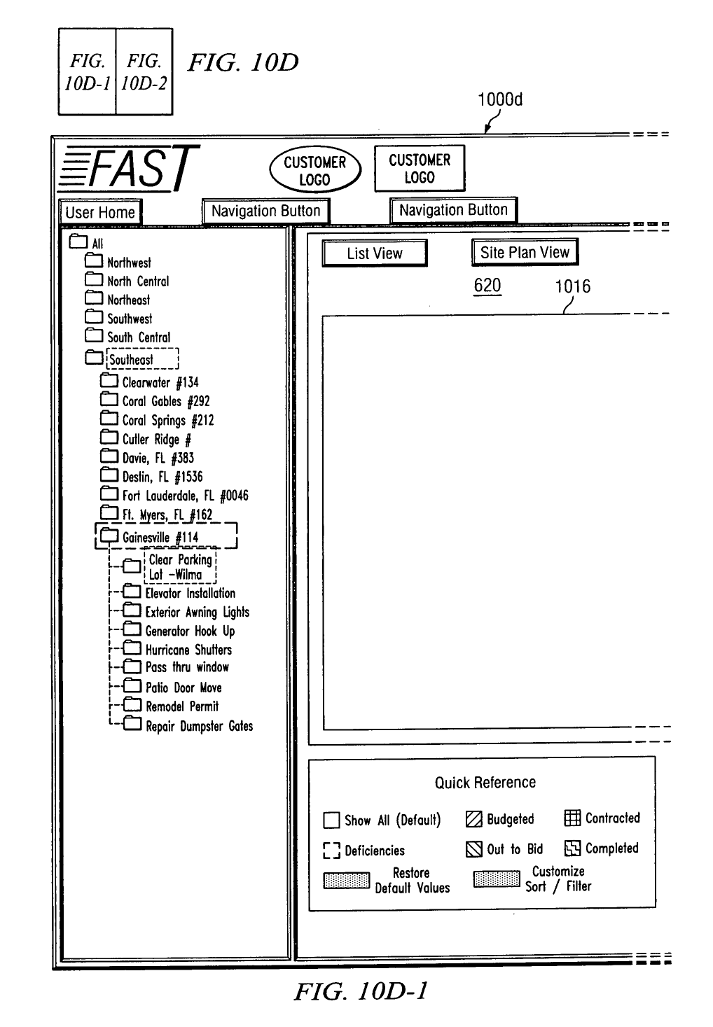

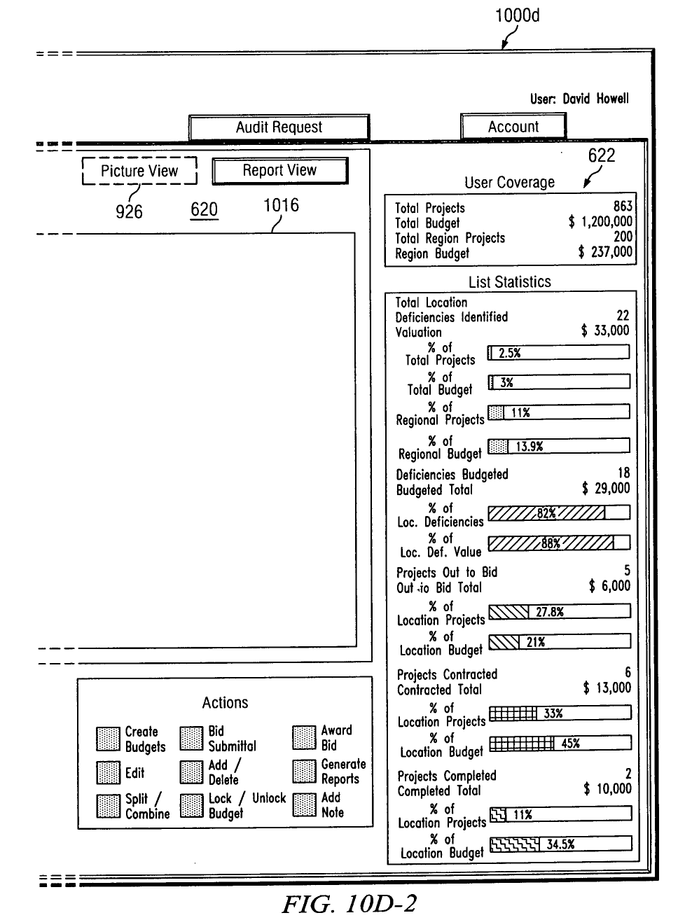

FIGS. 10A-10D are screenshots of exemplary graphical user interfaces 1000a-1000d showing lists of deficiencies, site plans of a deficiency, and picture of a deficiency determined during a site audit of the facilities. FIG. 10A is a screenshot of an exemplary GUI 1000a that shows a list view, as selected by a user selecting a list view soft-button 1002. The list view shows a list of deficiencies 1004 of a facility, Gainesville #114, selected by a user. The list of deficiencies 1004 may include deficiencies not yet budgeted, budgeted deficiencies, deficiencies that currently have RFPs sent out to potential bidders, deficiencies that have been contracted with vendors to repair, and deficiencies that have been completed. In addition, each deficiency that has been budgeted may include a quarter in which the deficiency is to be repaired. Each of the deficiencies may be accumulated in value in a totals line 1006, thereby showing total value of repairs for deficiencies at the selected facility.

FIG. 10B is a screenshot of another exemplary GUI 1000b showing a list view in the view region 620 of multiple facilities selected by a user. The multiple facilities are selected by the user by selecting multiple file folders 1008a-1008b (collectively 1008) representative of facilities. All of the deficiencies within each of the facilities may be shown in the view region 620 and values accumulated along a totals line 1010 so that the user may easily determine the total amount of repairs for deficiencies within the two facilities. It should be understood that more than two facilities may be selected, such as by selecting an entire region of facilities, such as the “Southeast” region that includes nine facilities. In addition, the statistics region 622 may show statistics for all of the selected facilities.

FIG. 10C is a screenshot of another exemplary GUI 1000c showing a site plan view 1012 within view region 620. The site plan view 1012 may include deficiency indicia 1014a-1014n, wherein the deficiency indicia are numbers shown in different colors or shades, for example. Again, the statistics region 622 may show statistics for the facility selected by the user.

FIG. 10D is a screenshot of another exemplary GUI 1000d that shows a picture view that includes a picture or photograph 1016 of a selected area, such as a parking lot, in response to a user selecting the picture view soft-button 926. The picture view soft-button 926 may provide thumbnails or, in response to a user selecting a particular thumbnail, a full photograph within the view region 620. The statistics region 622 may show statistics associated with the selected facility.

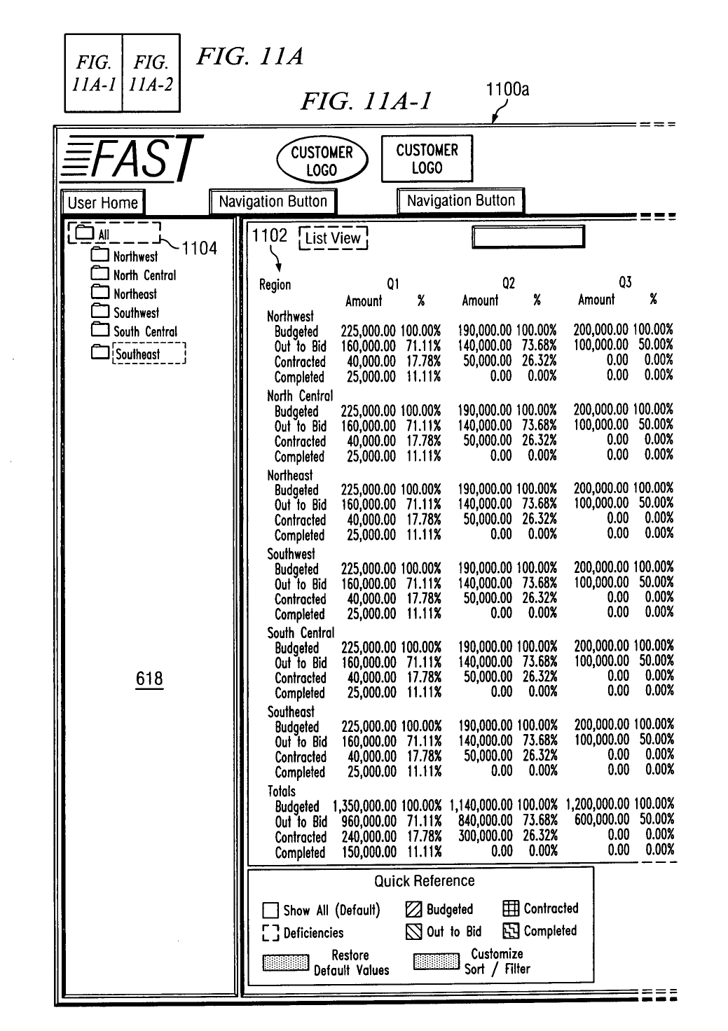

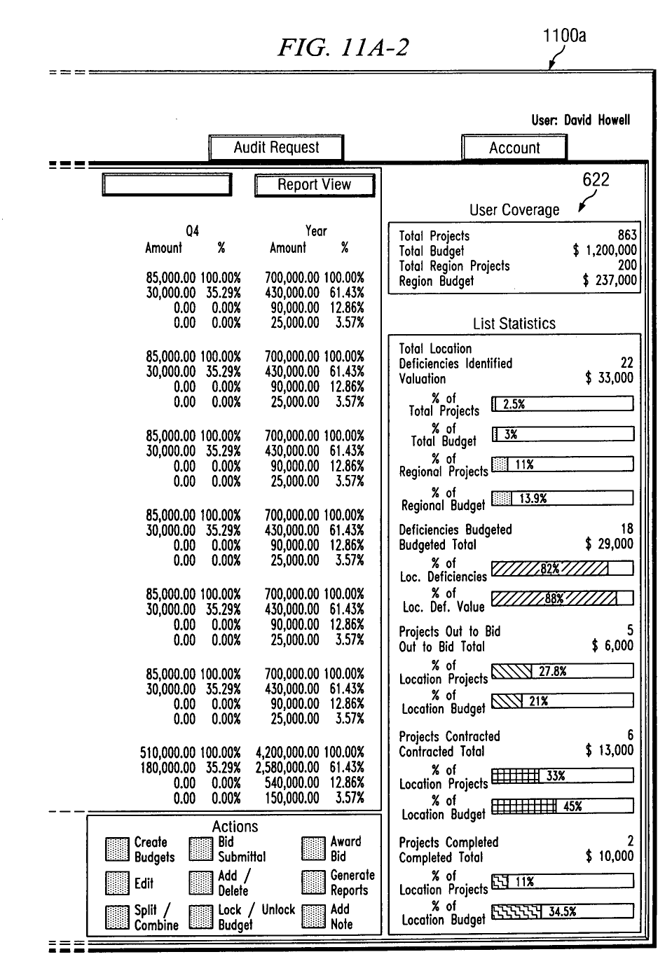

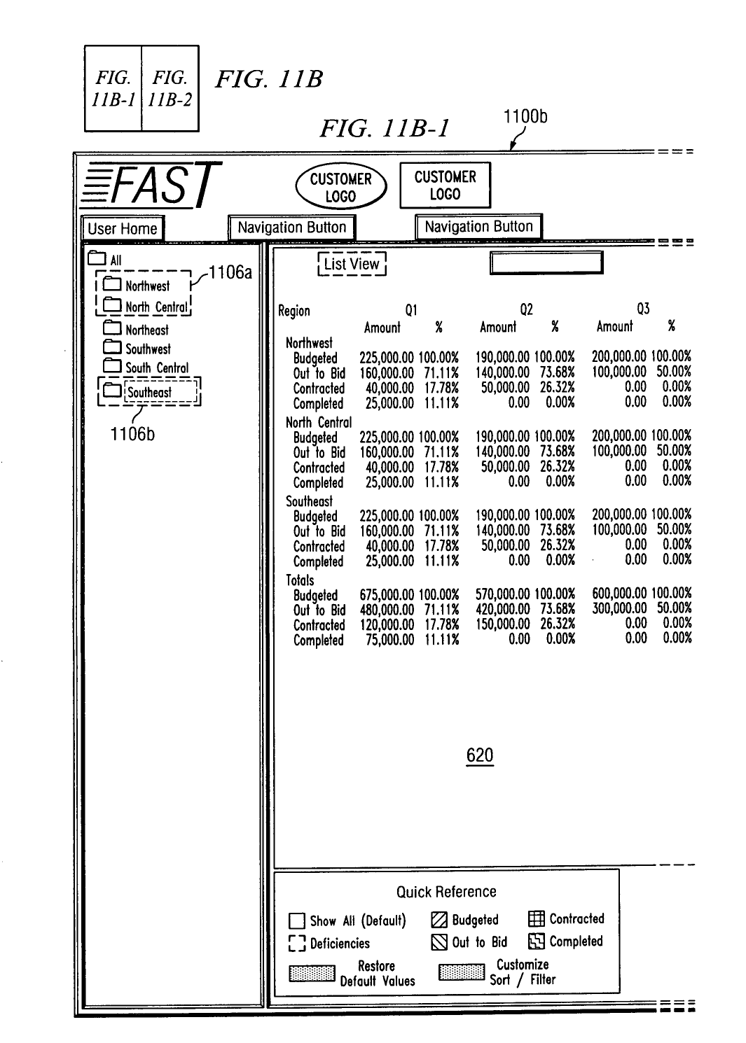

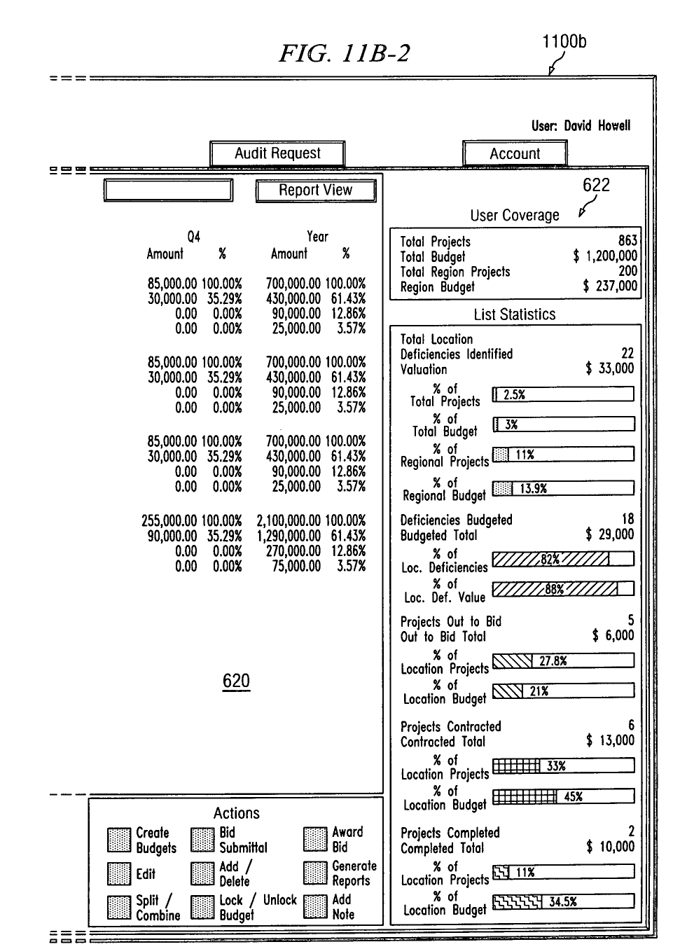

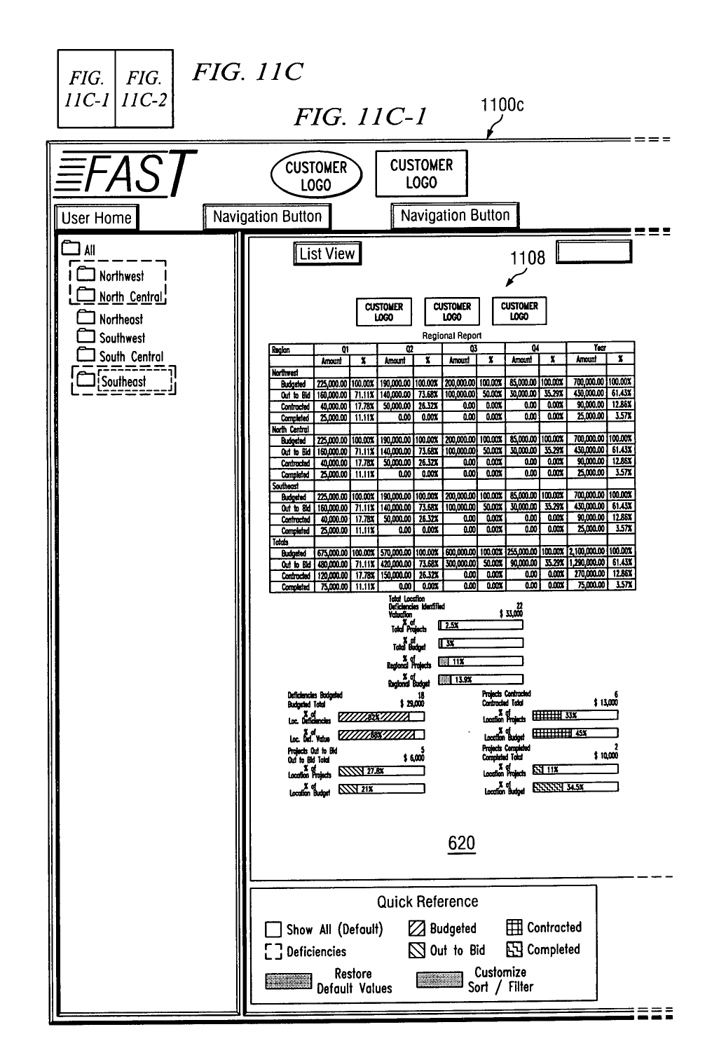

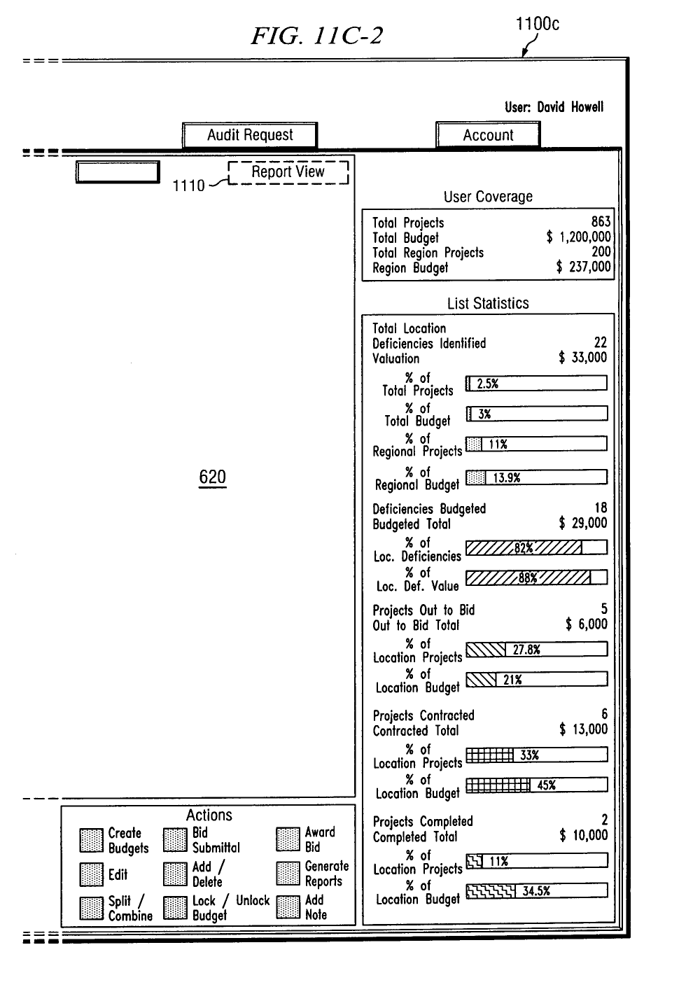

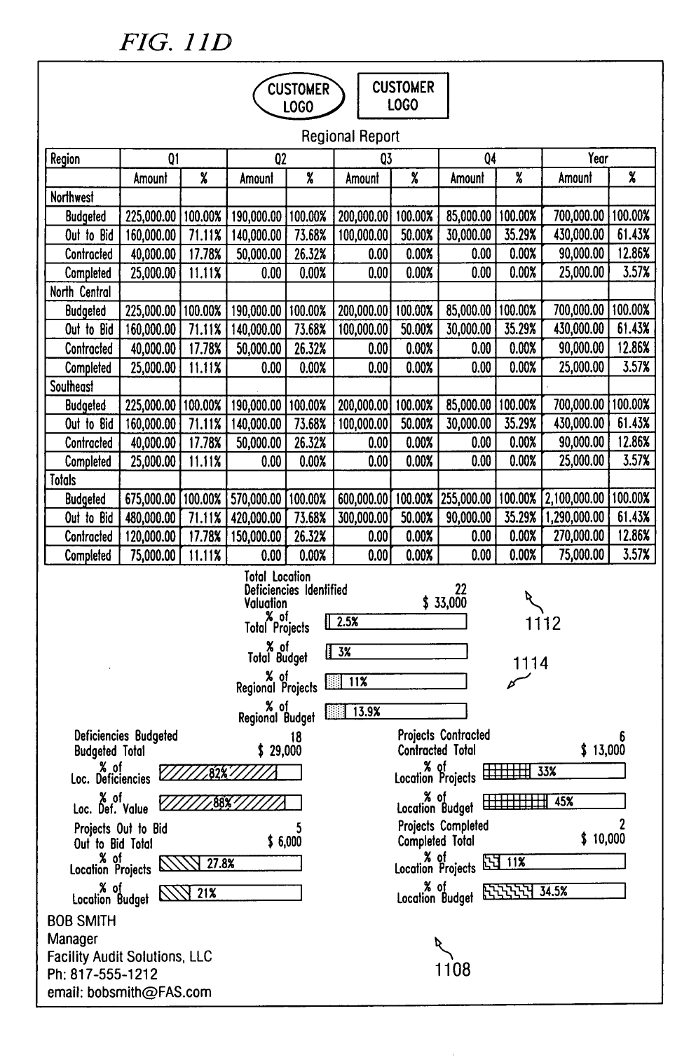

FIGS. 11A-11D are screenshots of exemplary graphical user interfaces 1100a-1100d when aggregated site audit information generated by determining deficiencies at facilities. FIG. 11A is a screenshot of an exemplary GUI 1100a showing a list view of all facilities within a customer's owned or operated asset base. As shown, the list view includes a list of regions 1102 in the same categorization as the regions listed in the navigation region 618. The list of regions includes categories associated with repairing deficiencies, including, “budgeted,” “out to bid,” “contracted,” and “completed.” Each of the categories may be listed in rows and columns organized by quarters (e.g., “Q1,” “Q2,” “Q3,” “Q4”). Each quarter may have a dollar amount and percentage for completion of repairs for a deficiency. A “year” column may also provide for the amount of money it will cost to repair a deficiency during the course of a calendar or fiscal year. A user may easily scan each of the regions and dollar amounts for repair and deficiencies determined from site auditing and totals may be provided so that the user may easily determine a total amount of money needed to perform the repairs of the deficiencies. In addition, the user may easily identify status of repairs based on the different rows (e.g., identified, budgeted, out to bid, contracted, and completed). In one embodiment, the user may “click” on percentages or dollar amounts within the view region 620 for further information about the components that are used to generate the percentages or dollar amounts data. The statistics region 622 maybe aggregated based on all the regions being selected, as identified by the highlighted box 1104, and the statistics may provide a graphical representation of the repairs and status of repairs to the user.

FIG. 11B is a screenshot of another exemplary GUI 1100b that shows that a user has selected three regions, “Northwest,” “North Central,” and “Southeast” as identified by the highlighted boxes 1106a and 1106b. As shown in the view area 620, each of these regions may be listed and information of repairs for deficiencies for each of these regions may be listed and totaled. Accordingly, the statistics region 622 may show statistics for these regions.

FIG. 11C is a screenshot of another exemplary GUI 1100c showing a report view 1108. In the view region 620, a response to the user selecting the report view soft-button 1110. The report view 1108 may show the lists in a spreadsheet format with statistics, including graphical representations of the statistics shown below. It should be understood that any configuration of report may be provided based on user preferences or as initially configured by the audit report manager.

FIG. 11D is a hard copy of a printed report, such as report 1108 that shows a spreadsheet region 1112 and graphics region 1114. The report may be printed as a hard copy, emailed or otherwise provided to a user. Report 1108 may have any configuration that the user desires, whether shown as quarterly breakdowns or otherwise.

One aspect of the audit management system includes being able to perform a custom query. A custom query is different from a search in that the query enables a user to select certain parameters to identify facilities for viewing information, such as facility information or site audit information for budgeting, planning or management purposes. Parameters of a customer query may include the below list:
1. Client
2. Concept
3. Prototype
4. Geography
   a. Region
   b. City
   c. State
   d. County
   e. Zip Code
   f. Radius
5. Personnel
   a. Usertypes
   b. Specific users
6. General Area
7. General Category
8. Type
9. Specific Item
10. Budget Amounts
11. Quantity and Dimension
12. Stage of Completion (“not scheduled, audited scheduled, deficiency, budgeted, out of bid, contracted, completed”)
13. Time Selections
   a. Year
   b. Quarter
   c. Not assigned
14. Priority (e.g., either priority or not priority)
   The list above is exemplary and all and/or additional parameters may be utilized to allow a user to perform a custom query on information stored in a database associated with site audits of facilities.

FIG. 12 is a screenshot of an exemplary custom query GUI 1200 to enable a user to query a database of facility information or site audit information. The GUI 1200 may include a search region 1202 that includes one or more text entry fields 1204 and drop-down menu fields 1206. The user may enter information into each of these fields. In addition, a user region 1208 may enable a user to enter his or her name, state, user type, region, or zip code to search for users within a user database. An audit region 1210 may include a list of parameters that a user may enter to search for site audits that have been or will be performed. The user may enter information into text entry fields or select parameters via drop-down menus. It should be understood that a variety of graphical user elements may be provided for a user to enter query parameters to query site audits that have been performed. Results of any of the facilities or queries may be provided in a list format or any other format as provided in previously described graphical user interfaces to enable a user to view accumulated information and statistical information of budgets, repairs, or any other information associated with deficiencies in facilities. Again, although the custom queries returns information resulting from a search, the information returned from the search may be used in a manner that may be different from a search as the custom query may result in information that is helpful to a user to manage facilities, whereas a search merely returns results from the search, such as names of facilities. However, a simple search may also provide the ability for a user to view information associated with a facility, for example.

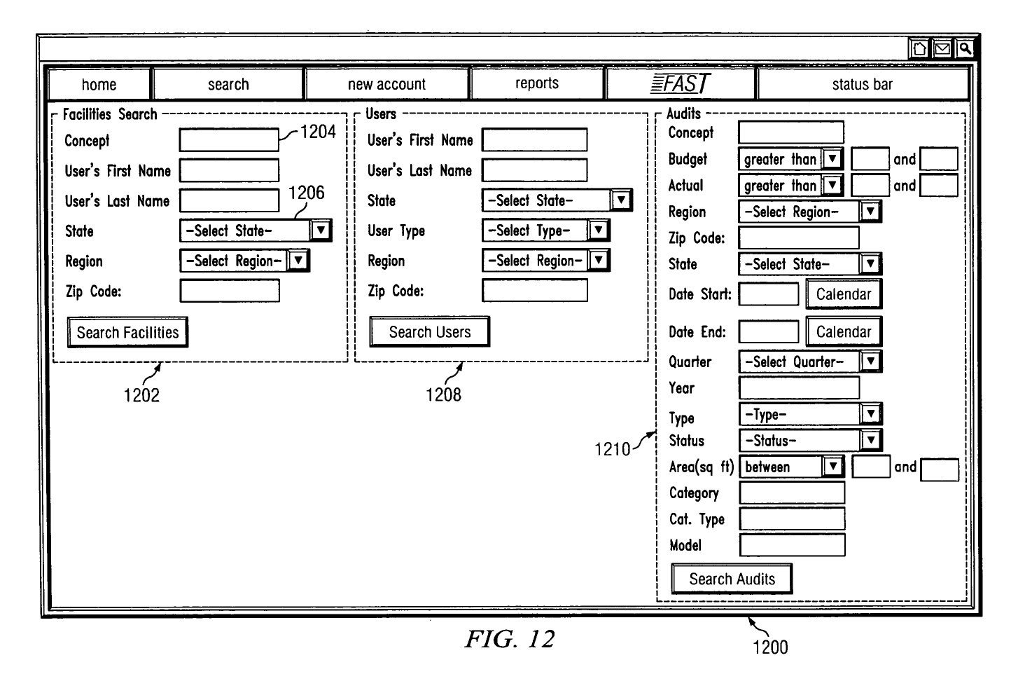

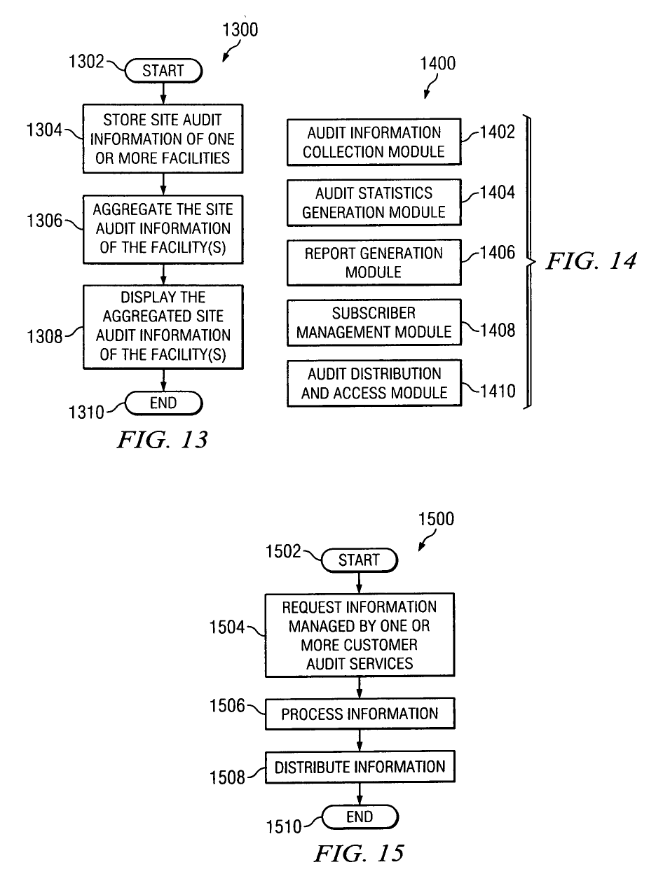

FIG. 13 is a flow chart of an exemplary process for managing site audit information. The process generally starts at step 1302. At step 1304, site audit information of one or more facilities is stored. The site audit information may include information associated with deficiencies found at the facility(s). The site audit information may include expected cost to repair the deficiencies, budgeted values to repair the deficiencies, and any other information that may be provided in association with deficiencies of a facility found during a site audit. At step 1306, the site audit information of the facility(s) may be aggregated. In aggregating the site audit information, the dollar amounts may be accumulated, percentages may be added, etc. Furthermore, the site audit information may be aggregated based on facilities selected by a user on a graphical user interface. At step 1308, the aggregated site audit information of the facility(s) may be displayed. The aggregated site audit information may be displayed on a graphical user interface using text or graphics. The process ends at step 1310.

FIG. 14 is a block diagram of exemplary software modules 1400 used to collect and manage site audit information of customers having facilities in an aggregate manner. The audit manager server modules 1400 may be software modules that are utilized by the audit manager server 306 (FIG. 3) used for performing a variety of functions for the audit manager 102 that are independent or in conjunction with the customer audit servers 302 and 304. The audit manager server modules 1400 may include an audit information collection module 1402, audit statistics generation module 1404, report generation module 1406, subscriber management module 1408 and audit distribution in access module 1410. The software modules 1400 are exemplary and may be combined or separated as understood in the art. In addition, other and/or alternative software modules may be utilized in accordance with the principles of the present invention.

The audit information collection module 1402 may be utilized to collect site audit information stored by each of the customer audit servers 302 and 304 (FIG. 3). The audit information collection modules 1402 may “sanitize” the site audit information collected from each of the customer audit servers so that users who access the collected site audit information may not be able to determine specifics as to which customer the site audit information is associated. By “sanitizing” the site audit information, the customers may have proprietary or private information protected. The audit information collection module 1402 may store the information in an aggregate format or otherwise.

The audit statistics generation module 1404 is a software module that may be configured to generate statistics of site audit information collected from customers. These statistics may provide statistics based on location, size of customer, types of deficiencies, or any other category as desired. The statistics generated may be utilized by customers or subscribers to determine trends or other information that may be helpful to customers, subscribers, vendors, or any other user.

The report generation module 1406 is a software module that may be configured to provide reports for subscribers to view of the statistics or site audit information in aggregate or other formats. The report generation module 1406 may further allow for predetermined reports or customized reports as created by a user.

The subscriber management module 1408 is a software module that may be configured to manage subscribers that have access to information collected by the audit manager server 306. The subscriber management module 1408 may be accessible by subscribers to add user names, passwords, manage accounts or otherwise, as understood in the art.

The audit distribution and access module 1410 is a software module that may be configured to provide distribution of site audit information to subscribers via electronic or hardcopy communication. The audit distribution in access module 1410 may distribute the site audit information, or facility information via reports distributed over a network using a “push” distribution model to subscribers or allow subscribers to access the reports via the audit manager server 306.

The subscribers that may access the site audit information may be any interested party that has a desire to follow trends or access relevant information associated with various industries, facilities, or any other facility. The subscribers may further be interested in following trends of quality of equipment or systems. The site audit information may provide information that is akin to reporting on quality of products and services to allow others in the various industries to determine whether one product or service is better than another based on site audits performed at facilities.

FIG. 15 is a flow chart of an exemplary process 1500 for collecting and managing site audit information collected from multiple customers of an audit manager. The process 1500 starts at step 1502. At step 1504, information managed by one or more customer audit servers is requested. The information may include facility information and site audit information. At step 1506, the information collected from the customer audit servers) may be processed. The processing may include performing an aggregation or generate statistics of the information. The processed information may be distributed to one or more subscribers at step 1508. The distribution may be performed using electronic communication or by enabling subscribers to access the processed information at an electronic address, such as a website. It should be understood that permission management may be utilized by the customer audit servers) to restrict subscribers from access to information other than certain industries, particular customers, or any other aggregated or statistical information as defined by a customer or audit manager. The process ends at step 1510.

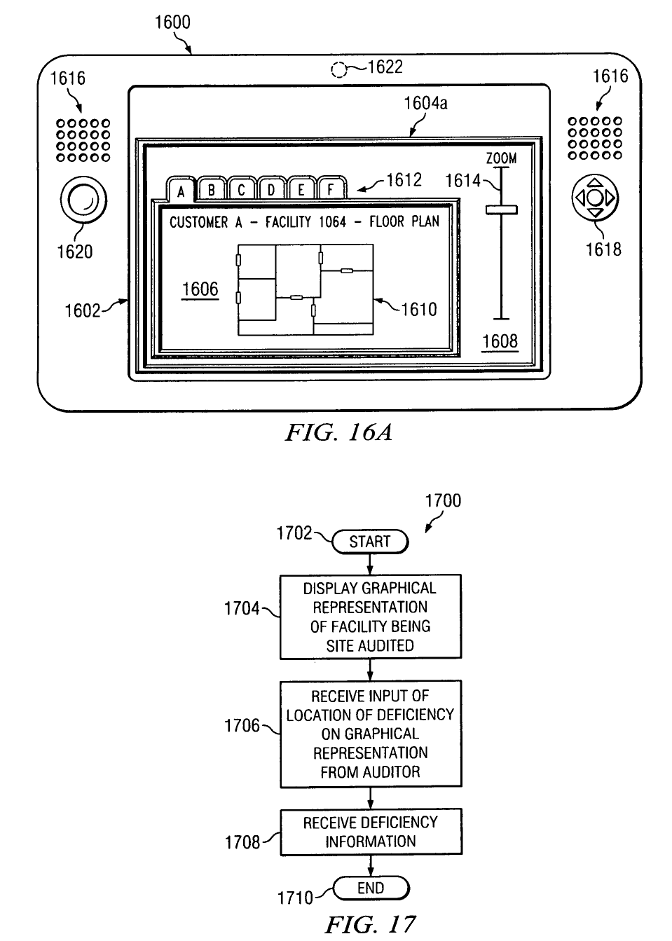

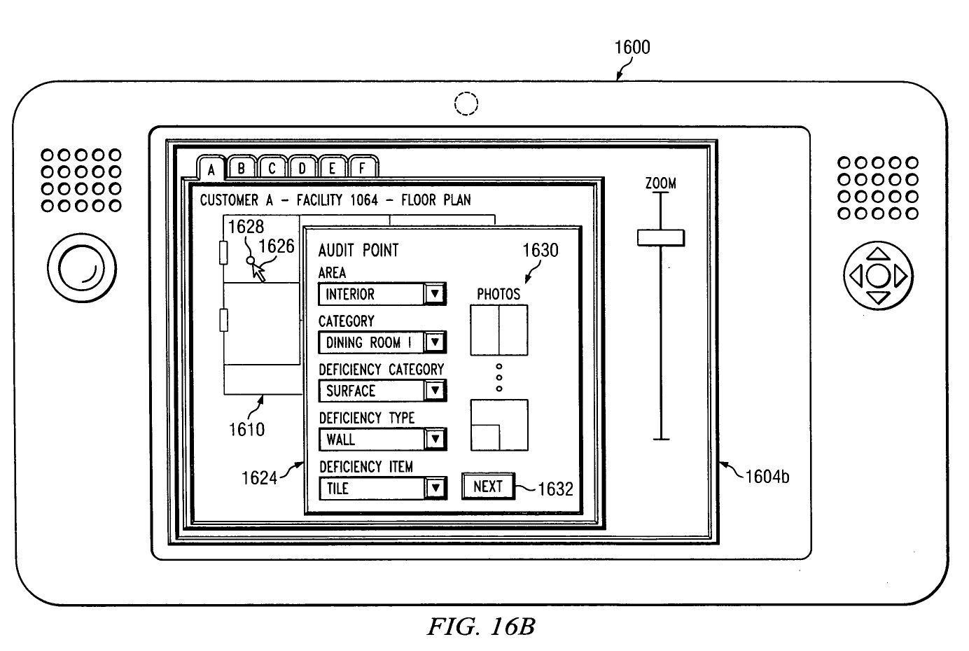

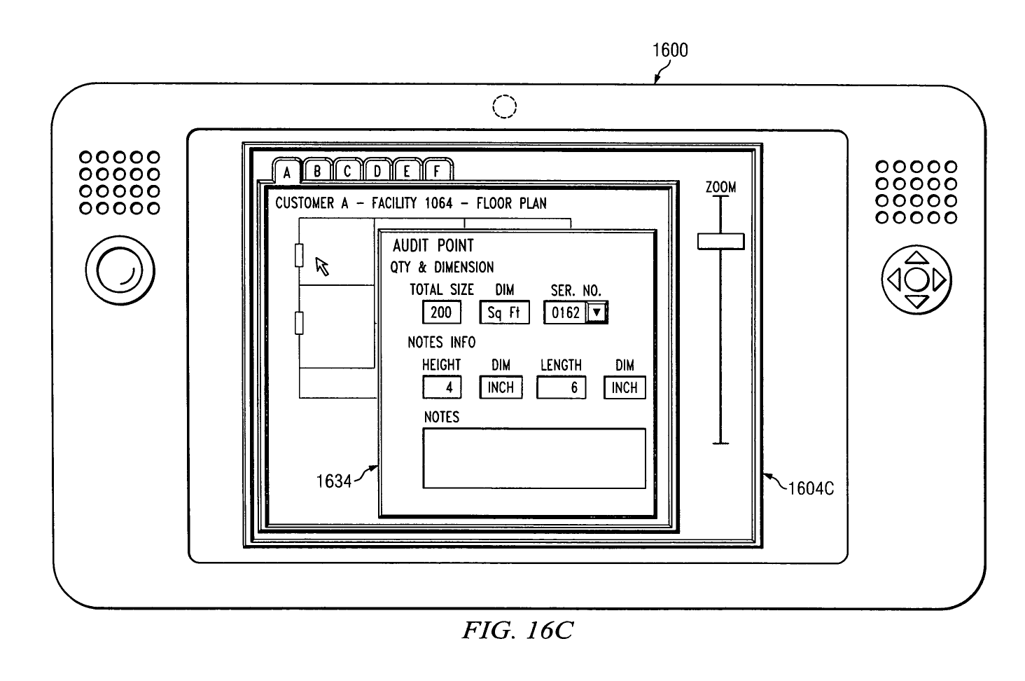

FIGS. 16A-16C are illustrations of an exemplary handheld computing device 1600 used for performing site audits on facilities. FIG. 16A is an illustration of the handheld computing device 1600, which may be any commercial handheld computing device, such as an ultra-mobile personal computer, tablet or any other electronic computed device. As understood in the art, the handheld computing device 1600 may include a processing unit that executes software, a memory unit, such as a hard drive and solid state memory, and input/output unit that may communicate via a wired and/or wireless connection. Although the handheld computing device 1600 may be configured to download facility information from a server to operate independently so as to not have to communicate via a network, which may be unavailable at an audit site or undesirable due to security reasons, the handheld computing device 1600 may operate by communicating via a wireless link and operate more as a terminal rather than an independent operating machine. However, for the purposes of this application, the handheld computing device 1600 operates as an independent device and is capable of downloading facility information so that an auditor may utilize that information during a site audit to create site audit information that includes information of deficiencies found at the facility.

The handheld computing device 1600 may include an electronic display 1602 that is configured to display a graphical user interface 1604a. The graphical user interface 1604a may include a view area 1606 and a control area 1608. The view area 1606 may display a graphical representation 1610 of a facility that is being audited by an auditor. For example, the graphical representation 1610 may be a floor plan. Alternatively, the graphical representation may be an elevation, photograph, schematic, or any other graphical representation, such that an auditor may identify locations of deficiencies at the facility. One or more tabs 1612 may be provided to enable an auditor to select different views of the facility. For example, the facility may have different areas, including parking lot, kitchen, entryway, seating area, bathrooms, downstairs, upstairs, etc., and each area may be represented by one or more graphical views such that an auditor may select a particular view of an area that he or she can see a deficiency location and mark the deficiency location on the graphical representation 1610. The function area 1608 may provide a zoom bar graphical element 1614 that an auditor may be able to zoom in or zoom out of the graphical representation 1610 during the site audit. In one embodiment, an auditor may “grab and drag” the graphical representation 1610 to view an area on the graphical representation 1610 not currently shown on the graphical user interface 1604a, as understood in the art.

The handheld computing device 1600 may also include a number of other functional elements, such as text entry keys 1616 that operate as keys of a keyboard, and set-up in a “qwerty” configuration. Alternatively, the handheld computing device 1600 may provide the ability to view soft text entry keys that may be displayed on the electronic display 1602 in the lower left and right corners of the electronic display 1602. These text entry keys 1616 may be utilized by the auditor to enter information associated with deficiencies identified during a site audit. In addition, a cursor movement device 1618 may enable the auditor to move a cursor on this electronic display 1602 to select an area or location at which to mark a deficiency. Alternatively, the electronic display 1602 may be a touch screen that senses a position of a finger or stylus when pressed against the electronic display 1602 so that the auditor may operate the handheld computing device 1600 via the graphical user interface 1604a. The deficiency may be automatically or manually given an identifier and may automatically or manually be defined with coordinates. The coordinates may be used in response to the auditor selecting a location of the deficiency to display an indicia (e.g., yellow triangle) while auditing. The coordinates may be stored in association with the identifier of the deficiency for later use in positioning the same or different indicia representative of the location of the deficiency on the same or other graphical representation.

Other function elements 1620 may be utilized to control various functions, including control of a digital camera 1622 that may have a lens located on the opposite side of the handheld computing device 1600 so that the auditor may take a photograph of a deficiency at a facility. Photographs may be stored on the handheld computing device 1600 on the memory unit. In another embodiment, the handheld computing device 1600 may have a communication port, such as a Bluetooth® communication standard communication port, which allows for a digital camera external from the handheld computing device 1600 to be utilized to take photographs at the facility and communicate wirelessly via the communication port the photograph taken of deficiencies at the facility. Alternatively, a wired port may be utilized to communicate the photographs. It should be understood that the handheld computing device 1600 may be configured to provide a variety of functions to enable the auditor to perform site audits at facilities efficiently. For example, software executed on a processor within the handheld computing device 1600 may be programmed to automatically associate photographs taken by the handheld computing device 1600 with a deficiency that is marked on the graphical representation 1610 by the auditor and stored in a data structure or other configuration.

FIG. 16B is an illustration of the handheld computing device 1600 showing GUI 1604b a pop-up window 1624 that allows for an auditor to enter information associated with a deficiency that is marked on the graphical representation 1610 by a cursor 1626 at a location or point 1628. The pop-up window 1624 may include a number of different entry fields, such as text entry fields, drop-down entry fields, or other graphical user elements that allow an auditor to quickly enter information associated with a deficiency. In one embodiment, the software may be programmed to establish an identifier, such as an alphanumeric value (e.g., def0173 (deficiency number), Bob7421 (auditor name and deficiency number), Starbucks43-012 (customer name, store number, deficiency number)), representative of the deficiency located by the user at the point 1628. In addition, the software may be programmed to identify and associate a location selected by the auditor that is within a particular area of the facility, and the pop-up window 1624 may be pre-filled with information as to the point 1628 selected by the auditor. For example, an area may be defined as interior, category defined as dining room 1, deficiency category defined as a surface, deficiency type defined as a wall, and deficiency item defined as a tile. Each of these deficiency information items maybe pre-established by a customer or audit manager. Photographs taken by the auditor using the handheld computing device 1600 may be placed into a photos region 1630. It should be understood that multiple photographs may be taken of a single deficiency to show different angles, views, lighting, etc. and that each of these photographs may be managed in association with the deficiency, both within the handheld computing device 1600 and when communicated to a server or storage and one or more databases. The photographs 1630 may be defined with an indicia associated with the deficiency automatically or by the auditor. A next soft-button 1632 may enable the auditor to move between pop-up windows to enter a complete set of information associated with a deficiency.

FIG. 16C is an illustration of the handheld computing device 1600 showing GUI 1604c with another pop-up window 1634 that enables the auditor to enter information of the deficiency to define quantity and dimension of the deficiency, such as total size, dimensions and serial number, notes information, including height and length and associated dimensions, and notes associated with the deficiency. The notes may allow an auditor to enter any type of note to provide for actions to be taken or any other information for which a manager may use in determining budgets to repair a deficiency. The quantity and dimension information may be used for preparing the budget or repair estimates based on information stored in a database that have defined cost information of types of materials and costs to repair such materials in various quantities. It should be understood that the information contained in the pop-up windows shown in FIGS. 16B and 16C are exemplary in that any graphical user interface and information used in the graphical user interfaces may be provided to an auditor for marking information of deficiencies. It should further be understood that the handheld computing device 1600 may be configured with a GUI to enable an auditor to perform an inventory in addition to performing a site audit to count assets at facilities.

An auditor or other user may edit photographs taken of deficiencies taken at a facility. The photographs may be edited to change contrast, brightness, or otherwise adjust a region of a photograph or an entire photograph. In addition, notes, circles, arrows, or other text or graphics may be digitally included on a photograph to identify a certain aspect of the photograph, such as a crack on a floor or ceiling.

The information generated by the auditor may be collected and stored within memory, such as a hard drive or electronic memory, for example, on the handheld computing device 1600 and uploaded to a server upon completion either manually or automatically. For example, with the handheld computing device 1600, which may be configured with wireless communications devices to communicate over a mobile telephone network or other network (e.g., Wi-Fi), the handheld computing device 1600 may communicate with the customer audit server and automatically upload the site audit information currently available and stored on the handheld computing device 1600.

FIG. 17 is a flow chart of an exemplary process 1700 for identifying and documenting deficiencies at a facility. The process 1700 starts at step 1702. At step 1704, a graphical representation of a facility being audited may be displayed. The graphical representation may be a floor plan, elevation, photograph, sketch, or any other graphical representation of a facility that is being audited. At step 1706, input of a location of a deficiency may be received on the graphical representation from the auditor. In one embodiment, the auditor may press a touch screen electronic display to identify the location of the deficiency. At step 1708, deficiency information may be received. In one embodiment, the deficiency information may be automatically generated based on the location of the deficiency on the graphical representation and presented to the auditor for verification and change, if the site audit information is incorrect as preprogrammed. The deficiency information may include other information that is not preprogrammed to be presented to the auditor, such as the size of an area to be repaired, equipment to be replaced, or otherwise. In addition, the deficiency information may include one or more photographs associated with each deficiency. The deficiency information, such as photograph(s) may be managed in a database, data structure, or other configuration. The process 1700 ends at step 1710.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A system for managing vendor information for repairing deficiencies at facilities, said system comprising:
a storage unit;
a data repository stored on said storage unit, and configured to store vendor information of vendors, the vendor information identifying one or more deficiencies of which at least one of the vendors is capable of repairing;
a processing unit in communication with said storage unit, and configured to locate one or more vendors, using the vendor information, capable of repairing a deficiency at a facility; and
a user interface configured to display the vendor information and enable selection of one or more vendors for repairing the deficiency at the facility.

2. The system according to claim 1, wherein the vendor information further identifies one or more geographic regions in which a vendor is willing to work.

3. The system according to claim 1, wherein the vendor information further includes scope of work information, the scope of work information including a threshold monetary value of work to be performed to repair one or more deficiencies.

4. The system according to claim 3, wherein said processing unit is further configured to determine whether a vendor is willing to work on a deficiency based on a budgeted value associated with the deficiency and whether the value crosses the threshold value.

5. The system according to claim 1, wherein said processing unit is further configured to communicate a message to an address of each vendor identified to be able to repair the deficiency.

6. The system according to claim 1, wherein said processing unit is further configured to aggregate site audit information to generate aggregated site audit information for multiple facilities.

7. The system according to claim 6, wherein said processing unit is further configured to generate a request for proposal based on the aggregated site audit information.

8. The system according to claim 1, wherein said user interface is further configured to enable a user to enter budget information in association with the site audit information.

9. A method for managing vendor information to repair deficiencies at facilities, said method comprising:
storing vendor information of vendors, the vendor information identifying one or more deficiencies of which at least one of the vendors is capable of repairing;
aggregating site audit information of one or more facilities; and
displaying vendor information of one or more vendors capable of repairing a deficiency at the facilities to enable selection of one or more vendors for repairing the deficiency at a facility.

10. The method according to claim 9, further comprising identifying one or more geographic regions in which a vendor is willing to work.

11. The method according to claim 9, further comprising identifying at least one vendor willing to repair a deficiency for a monetary value above or below a threshold monetary value.

12. The method according to claim 9, further comprising communicating a message to an address associated with each vendor capable of repairing the deficiency.

13. The method according to claim 9, further comprising aggregating site audit information association with multiple facilities.

14. The method according to claim 13, further comprising generating a request for proposal based on the aggregated site audit information.

15. The method according to claim 9, further comprising enabling a budget to be established for each deficiency of the facilities.
